(19) United States
(12) Patent Application Publication
(10) Pub. No.: US 2026/0167863 A1
(43) Pub. Date: Jun. 18, 2026

(54) CARBON QUANTUM DOTS AND METHODS OF PREPARATION THEREOF

(71) Applicant: Ramot at Tel-Aviv University Ltd., Tel Aviv (IL)

(72) Inventors: Vijay Bhooshan KUMAR, Tel Aviv (IL); Ehud GAZIT, Tel Aviv (IL)

(21) Appl. No.: 19/416,527

(22) Filed: Dec. 11, 2025

Related U.S. Application Data
(60) Provisional application No. 63/734,779, filed on Dec. 17, 2024.

(51) Int. Cl. C09K 11/65; C09K 113/00

(52) U.S. Cl. CPC C09K 11/65; C09K 2113/00

(57) ABSTRACT

The present invention provides a carbon quantum dot (CQD) derived from an N-containing organic precursor, comprising a graphitic core and a passivation shell layer. The CQD possesses enhanced optical and electrical properties and is therefore advantageous for use in applications such as optoelectronic devices, bioimaging, biosensing, and manipulation of cellular organelles in vivo. Further provided is a modified hydrothermal method for synthesizing and obtaining the CQD.

### TECHNICAL FIELD

The present invention relates to carbon quantum dots derived from amino acids, nucleotides, and derivatives thereof and methods of preparing same.

### BACKGROUND

Carbon nanomaterials have attracted significant attention in recent years due to their unique physical, chemical and biological properties. Examples of carbon nanomaterials of interest include fullerenes, nanotubes and graphene. More recently, carbon quantum dots (hereinafter “CQDs”), have emerged as an important carbon nanomaterial of interest.

A quantum dot is a nanoscale semiconductor particle which exhibits unique properties due to its quantum confinement effects. When the size of a semiconductor material is reduced to the nanometer scale (typically 1-10 nm), the motion of charge carriers (electrons and holes) is restricted in all three spatial dimensions. This confinement results in a formation of discrete energy levels rather than continuous energy bands that are found in bulk materials. As a result, quantum dots exhibit behaviors with different characteristics to those of larger scale materials, and can exhibit size-dependent optical and electrical properties.

CQDs are an innovative class of fluorescent nanomaterials with a quasi-spherical morphology (less than 10 nm in all three dimensions), distinctive physicochemical properties, and tunable electronic and optical properties. In addition to their tunability, other advantageous characteristics of CQDs include strong photoluminescence, high stability, chemical inertness, high water solubility, low fabrication cost, and low cytotoxicity. These advantageous characteristics of CQDs render them beneficial across a range of diverse applications, including biomedical imaging, displays, solar cells, sensors, drug delivery, gene delivery, cell imaging, diagnosis utilizing, fluorescence metal sensing, photocatalysis, dye degradation, photosynthesis augmentation, and photovoltaics.

CQDs can be synthesized from a variety of sources through a bottom-up approach. Potential carbon containing sources for synthesis of CQDs include carbohydrates, proteins, lipids, and other biological molecules, as well as renewable materials such as fruit and vegetable peels, nuts, and waste products. Alternatively, top-down methods allow for the synthesis of CQDs from pure carbon sources, including graphene, carbon nanotubes, and coal. However, CQDs composed solely of carbon, or more typically those primarily consisting of carbon with trace amounts of oxygen and hydrogen, generally exhibit suboptimal fluorescence properties. To overcome this limitation, nitrogen doping (N-doping) is frequently employed.

N-doping introduces new energy states and increases the electron density in the conduction band, thereby enhancing the fluorescence properties of CQDs. Furthermore, nitrogen atoms play a crucial role in passivating surface defects, which are often sites for non-radiative recombination which leads to fluorescence quenching. The nitrogen atoms which are incorporated through N-doping typically form bonds with oxygen-containing groups on the CQD surface, thereby improving surface passivation and preventing oxidation. This N-doping process therefore has the effect of mitigating fluorescence quenching, enhancing fluorescence properties, and increasing photostability.

WO 2018/082204 describes a red-emitting carbon dot having a high yield and quantum yield characterized by a spheroid composed of an inner core and an outer casing thereof, the core being graphitized carbon, and the outer shell being an amorphous functional group. The core and the outer shell are connected by a covalent bond, wherein the core has a diameter of 2 to 8 nm, and the outer shell has a thickness of 1 to 3 nm.

JP 2021088477 describes a CQD which is a carbide of a mixture containing (A) a lignin or a carbonized product thereof, (B) an aromatic compound comprising a hydroxy group and an amino group, and (C) an aliphatic polyamine.

CN 112251223 describes a nitrogen-doped fluorescent carbon dot based on citric acid and benzoylurea which is characterized in that the raw material consists of citric acid and benzoylurea with a mass ratio of the citric acid to the benzoylurea of 0.5-6.

CN 109504372 describes a fluorescent CQD solution characterized in that the fluorescent carbon quantum dot comprises hydrogen, 15%˜60% carbon, 10%˜50% oxygen, and 10%˜45 nitrogen, at a size of 1˜20 nm, wherein the solution has excitation in the range of 250˜530 nm and transmission in the range of 350˜650 nm.

WO 2021/087646 describes polycyclic compounds that are aromatic or partially aromatic, and are substituted with one or more alkyl groups having an amino group and a carboxylic acid group and CQDs that contain these compounds.

CN 103395771 describes carbon dots with high fluorescent quantum yield, which are synthesized using citric acid and ethene diamine as raw materials. Methods of production and uses thereof are disclosed, including fluorescent inkjet printing, fountain pen handwriting, and fluorescent micron array.

As an alternative to N-doping, nitrogen containing organic acids can be used for the formation of CQDs with favorable fluorescence properties.

There have been various reports for the formation of CQDs from amino acids (hereinafter “AAs”). Generally, AA-CQDs are synthesized through hydrothermal processes. For example, formation of nitrogen-containing CQDs with blue luminescence by hydrothermal treatment of several AAs was reported in Yang et al. (Hydrothermal Synthesis and Photoluminescent Mechanistic Investigation of Highly Fluorescent Nitrogen Doped Carbon Dots from Amino Acids. Mater. Res. Bull. 2017, 89, 26-32).

Formation of CQDs by pyrolyzing citric acid in the presence of various AAs under hydrothermal conditions was reported in Pandit et al. (In Situ Synthesis of Amino Acid Functionalized Carbon Dots with Tunable Properties and Their Biological Applications. ACS Appl. Bio Mater. 2019, 2, 3393-3403).

Furthermore, fabrication of CQDs by hydrothermal synthesis using nine AA precursors has been reported in Kolanowska et al. (Carbon Quantum Dots from Amino Acids Revisited: Survey of Renewable Precursors toward High Quantum-Yield Blue and Green Fluorescence. ACS Omega 2022, 7, 41165-41176.).

There remains a continued unmet need for CQDs with enhanced optical and electrical properties.

### SUMMARY

The present invention provides CQDs having high quantum yields and refractive indices, the CQDs are derived from amino acids or nucleotides. The present invention further provides a method of preparing the CQDs by a hydrothermal process. Further provided by the present invention are methods of use of the CQDs for cellular imaging.

Disclosed herein for the first time are CQDs having superior quantum yields and refractive indices that are obtained from amino acids or nucleotides. The CQDs are characterized by a graphitic core surrounded by a passivation shell layer comprising nitrogen and oxygen-containing oligomers and/or polymers. The present invention is based, in part, on the unexpected finding that increasing the surface passivation content to 16-20% by weight, provides CQDs possessing enhanced fluorescence and electrical properties. Accordingly, the CQDs of the present invention are advantageous for use in applications such as optoelectronic devices, bioimaging, biosensing, and manipulation of cellular organelles in vivo.

According to a first aspect, the present invention provides a CQD derived from a monolithic substance comprising an amino acid, wherein the CQD comprises a graphitic core and a passivation shell layer, wherein the passivation shell layer is at least 15% by weight of the CQD, wherein the CQD has a nitrogen content of at least 15% by weight of the CQD, and wherein the CQD is characterized by a fluorescence spectrum which is substantially devoid of an emission peak in the range of about 650-700 nm upon excitation at a wavelength in the range of 320-540 nm. In one embodiment, the passivation shell layer comprises at least one of a polyamide and a polyester.

According to some embodiments, the CQD is derived from a proteinogenic or a non-proteinogenic amino acid. Each possibility represents a separate embodiment. In some embodiments, the amino acid is a positively charged amino acid. In certain embodiments, the positively charged amino acid is selected from the group consisting of arginine, lysine, and histidine. Each possibility represents a separate embodiment. In other embodiments, the amino acid is a negatively charged amino acid. In various embodiments, the negatively charged amino acid is selected from the group consisting of aspartic acid and glutamic acid. Each possibility represents a separate embodiment. In further embodiments, the amino acid is an uncharged polar amino acid. In particular embodiments, the uncharged polar amino acid is selected from the group consisting of asparagine, glutamine, serine, threonine, tyrosine, and cysteine. Each possibility represents a separate embodiment. In additional embodiments, the amino acid is a non-polar amino acid. In specific embodiments, the non-polar amino acid is selected from the group consisting of alanine, valine, leucine, isoleucine, methionine, proline, phenylalanine, tryptophan, and glycine. Each possibility represents a separate embodiment. According to certain embodiments, the CQD is derived from histidine. According to other embodiments, the CQD is derived from arginine. According to further embodiments, the CQD is derived from lysine. According to some embodiments, the CQD is derived from threonine. According to further embodiments, the CQD is derived from asparagine. According to certain embodiments, the CQD is derived from proline.

According to a second aspect, there is provided a CQD derived from a nucleotide or metabolite thereof, wherein the CQD comprises a graphitic core and a passivation shell layer, wherein the passivation shell layer is at least 15% by weight of the CQD, wherein the CQD has a nitrogen content of at least 15% by weight of the CQD, and wherein the CQD is characterized by a fluorescence spectrum which is substantially devoid of an emission peak in the range of about 650-700 nm upon excitation at a wavelength in the range of 320-540 nm. In one embodiment, the passivation shell layer comprises at least one of a polyamide and a polyester.

According to some embodiments, the CQD is derived from a nucleotide. According to particular embodiments, the CQD is derived from adenine. According to other particular embodiments, the CQD is derived from adenosine. In various embodiments, the CQD is derived from a nucleotide and an organic acid selected from the group consisting of citric acid, malic acid, succinic acid, fumaric acid, tartaric acid, and oxalic acid. Each possibility represents a separate embodiment.

In certain embodiments, either of the amino acid or nucleotide is at a purity level of at least 95%. In other embodiments, either of the amino acid or nucleotide is at a purity level of at least 96%. In further embodiments, either of the amino acid or nucleotide is at a purity level of at least 97%. In additional embodiments, either of the amino acid or nucleotide is at a purity level of at least 98%. In specific embodiments, either of the amino acid or nucleotide is at a purity level of at least 99%. In some embodiments, either of the amino acid or nucleotide is at a purity level of greater than 99%.

In some embodiments, the polyamide and/or polyester comprise a long-chain polyamide and/or polyester. In some embodiments, the long-chain polyamide and/or polyester comprise 50-1000 repeating units, including each integer within the specified range. In some embodiments, the passivation shell layer further comprises at least one functional group selected from the group consisting of —COOH (carboxyl), —NH₂ (amino), —OH (hydroxyl), —CHO (formyl), and —C═O (carbonyl). Each possibility represents a separate embodiment.

In some embodiments, the CQD has a nitrogen content of at least 16% by weight. In some embodiments, the CQD has a nitrogen content of at least 17% by weight. In some embodiments, the CQD has a nitrogen content of at least 18% by weight. In some embodiments, the CQD has a nitrogen content of at least 19% by weight. In some embodiments, the CQD has a nitrogen content of at least 20% by weight. In some embodiments, the CQD has a nitrogen content within a range of 15%-25% by weight, including each value within the specified range.

In some embodiments, the CQD has a carbon content of at least 63% by weight. In some embodiments, the CQD has a carbon content of at least 65% by weight. In some embodiments, the CQD has a carbon content of at least 67% by weight. In some embodiments, the CQD has a carbon content of at least 69% by weight. In some embodiments, the CQD has a carbon content of at least 71% by weight. In some embodiments, the CQD has a carbon content within a range of 63%-72% by weight, including each value within the specified range.

In some embodiments, the passivation shell layer is at least 16% by weight of the CQD. In other embodiments, the passivation shell layer is at least 18% by weight of the CQD. In further embodiments, the passivation shell layer is within a range of 16%-20% by weight of the CQD, including each value within the specified range.

In some embodiments, the CQD has a diameter which is less than 20 nm. In other embodiments, the CQD has a diameter which is less than 15 nm. In certain embodiments, the CQD has a diameter which is less than 10 nm. In further embodiments, the CQD has a diameter in a range of 2-10 nm, including each value within the specified range.

In some embodiments, the CQD has a quantum yield at or above 45%. In other embodiments, the CQD has a quantum yield at or above 50%. In other embodiments, the CQD has a quantum yield at or above 55%. In other embodiments, the CQD has a quantum yield at or above 60%. In other embodiments, the CQD has a quantum yield at or above 65%. In other embodiments, the CQD has a quantum yield in a range of 65% to 90%, including each value within the specified range.

In certain embodiments the CQD has a refractive index (RI) at or above 1.35. In certain embodiments, the CQD has an RI at or above 1.45. In other embodiments, the CQD has an RI at or above 1.55. In certain embodiments, the CQD has an RI at or above 1.65. In some embodiments, the CQD has an RI at or above 1.75. In some embodiments, the CQD has an RI at or above 1.85. In some embodiments, the CQD has an RI at or above 1.95. In other embodiments, the CQD has an RI at or above 2.05. In other embodiments, the CQD has an RI at or above 2.15. In other embodiments, the CQD has an RI in a range of 1.6 to 2.2, including each value within the specified range.

In certain embodiments, the CQD has a fluorescence decay time at or above 0.05 ns. In various embodiments, the CQD has a fluorescence decay time at or above 0.1 ns. In other embodiments, the CQD has a fluorescence decay time at or above 0.15 ns. In particular embodiments, the CQD has a fluorescence decay time at or above 0.5 ns. In some embodiments, the CQD has a fluorescence decay time at or above 1.0 ns. In some embodiments, the CQD has a fluorescence decay time at or above 2.0 ns. In other embodiments, the CQD has a fluorescence decay time at or above 3.0 ns. In some embodiments, the CQD has a fluorescence decay time at or above 4.0 ns. In some embodiments, the CQD has a fluorescence decay time at or above 5.0 ns. In other embodiments, the CQD has a fluorescence decay time at or above 6.0 ns.

In certain embodiments, the graphitic core is highly crystalline. In some embodiments, the graphitic core has electron diffraction lattice fringes with d-spacing at or above 0.20 nm. In other embodiments, the graphitic core has electron diffraction lattice fringes with d-spacing at or above 0.21 nm. In further embodiments, the graphitic core has electron diffraction lattice fringes with d-spacing at or above 0.22 nm. In other embodiments, the graphitic core has electron diffraction lattice fringes with d-spacing at or above 0.23 nm. In some embodiments, the graphitic core has electron diffraction lattice fringes with d-spacing in a range of 0.20-0.24 nm, including each value within the specified range.

In certain aspects and embodiments, there is provided a CQD obtainable by the process comprising the steps of:
a) dissolving an amino acid, a nucleotide or a metabolite thereof in an aqueous medium, thereby forming an aqueous solution;
b) heating the aqueous solution of step (a) to a temperature of about 200° C. or higher for a predetermined time period; and
c) gradually cooling the aqueous solution of step (b) to room temperature thereby recovering CQDs therefrom.

In other aspects and embodiments, there is provided a process of synthesizing a CQD, the process comprising the steps of:
a) dissolving an amino acid, a nucleotide or a metabolite thereof in an aqueous medium, thereby forming an aqueous solution;
b) heating the aqueous solution of step (a) to a temperature of about 200° C. or higher for a predetermined time period; and
c) gradually cooling the aqueous solution of step (b) to room temperature thereby recovering CQDs therefrom.

In certain embodiments, step (a) comprises dissolving an amino acid. In other embodiments, step (a) comprises dissolving a nucleotide. In further embodiments, step (a) of dissolving a nucleotide in an aqueous medium further comprises dissolving an organic acid in the aqueous medium. In some embodiments, the organic acid is selected from the group consisting of citric acid, malic acid, succinic acid, fumaric acid, tartaric acid, and oxalic acid. Each possibility represents a separate embodiment. In some embodiments, step (a) of dissolving an amino acid, a nucleotide or a metabolite thereof is performed at a temperature above 80° C. In some embodiments, step (a) of dissolving an amino acid, a nucleotide or a metabolite thereof is performed at a temperature above 85° C. In some embodiments, step (a) of dissolving an amino acid, a nucleotide or a metabolite thereof is performed at a temperature in a range of 80° C.-90° C., including each value within the specified range.

In certain embodiments, step (b) of heating the aqueous solution is performed in an autoclave. In various embodiments, the predetermined time period of step (b) is equal to or longer than 6 hours. In other embodiments, the predetermined time period of step (b) is equal to or longer than 7 hours. In some embodiments, the predetermined time period of step (b) is equal to or longer than 8 hours. In other embodiments, the predetermined time period of step (b) is equal to or longer than 9 hours. In certain embodiments, the predetermined time period of step (b) is in a range of 6-10 hours, including each value within the specified range.

In additional embodiments, the gradual cooling of the aqueous solution in step (c) is performed at a cooling rate of 0.1-10° C./min, including each value within the specified range. In further embodiments, the gradual cooling of the aqueous solution in step (c) is performed at a cooling rate of 0.1-8° C./min, including each value within the specified range. In other embodiments, the gradual cooling of the aqueous solution in step (c) is performed at a cooling rate of 0.1-6° C./min, including each value within the specified range. In additional embodiments, the gradual cooling of the aqueous solution in step (c) is performed at a cooling rate of 0.1-4° C./min, including each value within the specified range. In some embodiments, the gradual cooling of the aqueous solution in step (c) is performed at a cooling rate of 0.1-2° C./min, including each value within the specified range. In further embodiments, the gradual cooling of the aqueous solution in step (c) is performed at a cooling rate in a range of 2-4° C./min. In additional embodiments, the gradual cooling of the aqueous solution in step (c) is performed at a cooling rate in a range of 4-6° C./min. In specific embodiments, the gradual cooling of the aqueous solution in step (c) is performed at a cooling rate in a range of 6-8° C./min. In certain embodiments, the gradual cooling of the aqueous solution in step (c) is performed at a cooling rate in a range of 8-10° C./min. In various embodiments, the gradual cooling of the aqueous solution in step (c) is performed at a cooling rate in a range of 0.5-1.5° C./min. In certain embodiments, the gradual cooling of the aqueous solution in step (c) is performed at a cooling rate of about 1° C./min.

In some embodiments, the CQD as disclosed herein is used in optoelectrical devices. In other embodiments, the CQD as disclosed herein is used in bioimaging. In further embodiments, the CQD as disclosed herein is used in biosensing. In other embodiments, the CQD as disclosed herein is used for manipulation of cellular organelles in vivo.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE FIGURES

The patent or application file contains at least one drawing executed in color. Copies of this patent or patent application publication with color drawings will be provided by the Office upon request and payment of the necessary fee.

FIG. 1. Schematic representation of the formation of AA-CQDs from AAs depicting proposed stages of formation of the AA-CQDs using a modified hydrothermal method.

FIGS. 2A-2D. AA-CQD suspensions as viewed in (2A) ambient white light and (2B) UV light. AAs in water prior to the formation of AA-CQDs (hereinafter “pristine AAs”) as viewed in (2C) ambient white light and (2D) UV light.

FIG. 3. Morphological analysis using TEM, HRTEM and SAED of Arg-CQD, His-CQDs, Lys-CQDs, Asp-CQDs, Gly-CQDS, as well as particle size histograms (PSD) of the AA-CQDs.

FIG. 4. A graphical representation of UV-VIS spectra for the AA-CQDs.

FIGS. 5A-5F. XPS analysis of AA-CQDs: Complete XPS spectrum (5A), high resolution spectra for C 1s (5B), N 1s (5C), O 1s (5D), Photoluminescence (PL) emission spectra of Arg-CQDs at λₑₓₜ=360 nm and quinine sulfate (5E), and PL decay time of Arg-CQDs on a logarithmic scale (5F).

FIG. 6. Graphical representations of fluorescence spectra of the AA-CQDs.

FIG. 7. Graphical representation of Quantum Yields (QYs) of all 20 AA-CQDs.

FIG. 8. Graphical representations of PL decay lifetimes for all AA-CQDs.

FIG. 9. Graphical representation of RI values of all AA-CQDs, grouped by charge, hydrophobicity, polarity, and aromaticity.

FIG. 10. Graphical representations of RI values for all 20 AA-CQDs for illumination wavelengths of 490, 500, 515, 530, 620, 641, 650, and 680 nm.

FIG. 11. Cell viability measurements of all 20 AA-CQDs by MTT assay on Hela cell line. Red: positively charged, cyan: negatively charged, green: uncharged side chain, orange: special cases-proline, cysteine and glycine-pH dependent neutral charge, blue: hydrophobic side chain.

FIG. 12. Live cell imaging of Arg-CQDs, His-CQD, Lys-CQDs, Thr-CQDs, Ser-CQDs, Asp-CQDs, and Pro-CQDS, in Hela cells. Images using four fluorescence channels: bright field images, Hoechst (dye staining live cell nucleus), excitation at 480 nm, and excitation at 540 nm. A z-stack taken by a confocal microscope provides a 3D-projection showing the Hela cell with corresponding CQD nanomaterials.

FIGS. 13A-13B. Morphological analysis using TEM of Adenosine-CQDs.

FIGS. 14A-14B. Morphological analysis using TEM of Uracil-CQDs.

FIGS. 15A-15B. Morphological analysis using TEM of Thymine-CQDs.

FIGS. 16A-16B. Morphological analysis using TEM of Cytosine-CQDs.

FIGS. 17A-17B. Morphological analysis using TEM of Guanine-CQDs.

FIGS. 18A-18B. Morphological analysis using TEM of Canavanine-CQDs.

FIGS. 19A-19E. Graphical representations of fluorescence spectra of the nucleotide-CQDs. Adenine-CQDs (19A), Cytosine-CQD (19B), Guanine-CQDs (19C), Thymine-CQDs (19D), and Uracil-CQDs (19E).

### DETAILED DESCRIPTION OF EMBODIMENTS OF THE INVENTION

Disclosed herein for the first time is a CQD synthesized from an N-containing organic precursor. The CQD comprises a graphitic core and a passivation shell layer constituting 16%-20% by weight of the CQD. The CQD of the present invention exhibits enhanced fluorescence and electrical properties. Without being bound by any particular theory, the enhanced fluorescence and electrical properties of the CQD stem from the high degree of nitrogen doping of the graphitic core as well as the overall nitrogen content and surface passivation content. The CQD of the present invention is advantageous for use in applications such as optoelectronic devices, bioimaging, biosensing, and manipulation of cellular organelles in vivo. The CQD disclosed herein is synthesized using a modified hydrothermal process. In some embodiments, the modified hydrothermal process involves dissolving the N-containing precursor in an aqueous medium and heating the resulting aqueous solution to about 200° C., followed by cooling in a gradual and controlled manner.

In some embodiments, the CQD is prepared using a monolithic substance. The term “monolithic substance” as used herein, refers to a substance comprising a single component. In various embodiments, the single component comprises an amino acid (hereinafter “AA-CQD”). According to the principles of the present invention, any amino acid can be used to form the CQD including, but not limited to, L-amino acids, D-amino-acids, and non-proteinogenic amino acids. Each possibility represents a separate embodiment. Within the scope of the present invention are CQDs derived from alanine (Ala/A), arginine (Arg/R), asparagine (Asn/N), aspartic acid (Asp/D), cysteine (Cys/C), glutamic acid (Glu/E), glutamine (Gln/Q), glycine (Gly/G), histidine (His/H), isoleucine (Ile/I), leucine (Leu/L), lysine (Lys/K), methionine (Met/M), phenylalanine (Phe/F), proline (Pro/P), serine (Ser/S), threonine (Thr/T), tryptophan (Trp/W), tyrosine (Tyr/Y), and valine (Val/V). Each possibility represents a separate embodiment. Further included within the scope of the present invention are amino acids which are non-proteinogenic such as, but not limited to, canavanine, thialysine, quisqualic acid, penicillamine, and the like. Each possibility represents a separate embodiment.

AA-CQDs disclosed herein can be further defined according to the side-chain properties of the amino acid used. For example, the amino acid can be a positively charged amino acid, including but not limited to arginine, lysine, and histidine. Alternatively, the amino acid can be a negatively charged amino acid such as, but not limited to, aspartic acid and glutamic acid. In addition, the amino acid can be an uncharged polar amino acid including, but not limited to, asparagine, glutamine, serine, threonine, tyrosine, and cysteine. Lastly, the amino acid can be a non-polar amino acid such as, but not limited to, alanine, valine, leucine, isoleucine, methionine, proline, phenylalanine, tryptophan, and glycine.

In some embodiments, the CQD is derived from an amino acid in the presence of an organic acid, particularly a polycarboxylic acid containing two or more carboxylic groups including, but not limited to, citric acid, malic acid, succinic acid, fumaric acid, tartaric acid, and oxalic acid. Each possibility represents a separate embodiment. In one embodiment, the CQD is derived from an amino acid in the presence of citric acid in an amount ranging from 1 to 20 wt. %, including each value within the specified range.

In various embodiments, the CQD is derived from a nucleic acid, nucleotide or metabolite thereof (hereinafter “NA-CQD”). As used herein, the term “nucleotide or metabolite thereof” refers to either a synthetic or natural nucleotide or a nitrogen-containing compound derived from such a nucleotide, including various nucleotide-derived nitrogenous compounds disclosed herein. Optionally, an NA-CQD is derived in the presence of an organic acid, particularly a polycarboxylic acid containing two or more carboxylic groups. Within the scope of the present invention are polycarboxylic acids selected from the group consisting of citric acid, malic acid, succinic acid, fumaric acid, tartaric acid, and oxalic acid. Without being bound by any particular theory, it is contemplated that an NA-CQD derived from nucleotides in the presence of an organic acid comprising two or more carboxylic groups feature a passivation shell layer comprising a polyamide and/or a polyester.

Nucleotides within the scope of the present invention include adenine, cytosine, guanine, thymine, and uracil. Each possibility represents a separate embodiment. Additional N-containing organic precursors for the formation of CQDs include, but are not limited to, natural or synthetic nucleosides, such as, but not limited to, purines, pteridine, pyrimidine, hypoxanthine, xanthine, uric acid, isoguanine, theobromine, isoxanthopterin, xanthopterin, guanosine, cytidine, thymidine, uridine, adenosine, and inosine or derivatives thereof. Each possibility represents a separate embodiment.

In certain embodiments, the N-containing organic precursor is at a purity level of at least 95%. In other embodiments, the N-containing organic precursor is at a purity level of at least 96%. In further embodiments, the N-containing organic precursor is at a purity level of at least 97%. In additional embodiments, the N-containing organic precursor is at a purity level of at least 98%. In specific embodiments, the N-containing organic precursor is at a purity level of at least 99%. In some embodiments, the amino acid is at a purity level of greater than 99%.

The CQD disclosed herein is synthesized using a modified hydrothermal process. In some embodiments, the modified hydrothermal process involves dissolving the N-containing precursor in an aqueous medium, followed by heating the resulting aqueous solution and then gradually cooling the solution in a controlled manner. In various embodiments, CQDs obtained by the modified hydrothermal process comprise a graphitic core and a passivation shell layer.

As used herein, the term “graphitic core” refers to a core region of the CQD, which comprises layers of sp² hybridized carbon atoms arranged in a graphene-like structure linked by Van der Waals bonding, wherein “graphene” means a two-dimensional monoatomic layer having trigonal sp² covalent bonding of carbon atoms. In certain embodiments, the graphitic core is highly crystalline. In some embodiments, the graphitic core has electron diffraction lattice fringes with d-spacing at or above 0.20 nm. In other embodiments, the graphitic core has electron diffraction lattice fringes with d-spacing at or above 0.21 nm. In further embodiments, the graphitic core has electron diffraction lattice fringes with d-spacing at or above 0.22 nm. In other embodiments, the graphitic core has electron diffraction lattice fringes with d-spacing at or above 0.23 nm. In some embodiments, the graphitic core has electron diffraction lattice fringes with d-spacing in a range of 0.20-0.24 nm, including each value within the specified range.

In some embodiments, the degree of crystallinity may be evidenced by the observation of clear lattice fringes in high-resolution transmission electron microscopy (HRTEM) images. In other embodiments, the degree of crystallinity may be evidenced by ring diffraction patterns in selected area electron diffraction (SAED) analysis. In some embodiments, lattice fringes within the specified d-spacing range and corresponding ring diffraction patterns observed in certain CQDs are characteristic of sp²-hybridized graphitic carbon. In these embodiments, the lattice fringes indicate that the carbon atoms within the core are arranged in ordered graphitic layers. Without being bound by any particular theory, it is contemplated that such structural ordering contributes to enhanced optical properties of the CQDs, including higher refractive index, improved fluorescence stability, and longer photoluminescence decay time.

According to the principles of the present invention, due to the use of AAs and NAs for the production of CQDs, the graphitic core is nitrogen doped. In some embodiments, the nitrogen content in the N-doped graphitic core ranges between about 0.01% at. and about 1% at., including each value within the specified range. In certain embodiments, the nitrogen content in the N-doped graphitic core ranges between about 0.1% at. and about 1% at., including each value within the specified range. In particular embodiments, the nitrogen content in the N-doped graphitic core ranges between about 0.1% at. and about 0.5% at., including each value within the specified range.

While the AA-CQDs and NA-CQDs are primarily N-doped, additional dopings are also contemplated by the present invention. For example, the CQDs may be further doped with atomic metals or metal ions selected from the group consisting of Zn²⁺, Fe²⁺, Cu²⁺, Mo²⁺, and the like. Each possibility represents a separate embodiment. Typically, the amount of doping with atomic metals or metal ions ranges between 0.05 to 0.5 wt. % of the carbon quantum dots (CQDs), including each value within the specified range.

Advantageously, AAs and NAs which the CQD can be derived from are renewable, abundant in nature, relatively inexpensive, and nontoxic. In addition to the incorporation of nitrogen to dope the carbon core, the nitrogen atoms are also incorporated into the passivation shell layer.

As detailed hereinabove, the CQD of the present invention comprises a passivation shell layer substantially surrounding or encapsulating the graphitic core. In these embodiments, a core-shell morphology is formed. The term “passivation shell layer” as used herein, refers to a structural region covering at least a portion of the surface of the CQD core. In some embodiments, the passivation shell layer covers at least 10%, 20%, 30%, 40%, 50%, 60%, 70%, 80%, 90%, or even 100% of the surface of the CQD core. In various embodiments, the passivation shell layer comprises a plurality of layers. Throughout this disclosure, the terms “passivation shell layer” and “passivation layer” can be used interchangeably and it is understood that both terms refer to the same specific structural region. In some embodiments, the passivation shell layer is amorphous.

The passivation shell layer can comprise heteroatom-containing material, including, but not limited to polymers, oligomers, or small-molecule residues containing functional groups. The term “heteroatom” as used herein refers to an atom other than carbon selected from nitrogen, sulfur, phosphorus, and oxygen. In some embodiments, the heteroatoms comprise nitrogen. In other embodiments, the heteroatoms comprise oxygen. In certain embodiments, the heteroatoms comprise a combination of two or more heteroatoms as detailed herein. In various embodiments, an amino acid can polymerize on the surface of an AA-CQD to form a polyamide. In accordance with these embodiments, the passivation shell layer comprises a polyamide. In certain embodiments, the polyamide can comprise 50-1000 repeating units. In other embodiments, the amino acids can polymerize on the surface of an AA-CQD to form a polyester by polymerization through their side chains. In accordance with these embodiments, the passivation shell layer comprises a polyester.

In some embodiments and aspects, the passivation shell layer of NA-CQDs also comprises at least one polymer selected from a polyamide and a polyester which may be a phospho-ester. Additionally or alternatively, the passivation shell layer of both AA-CQDs and NA-CQDs can comprise one or more functional groups including, but not limited to amide (—CONH—), ester (—COO—), hydroxyl (—OH), amino (—NH₂), carbonyl (—C═O), formyl (—CHO), or carboxyl (—COOH) groups. Each possibility represents a separate embodiment.

In some embodiments, a passivation shell layer constitutes at least 15% by weight of the CQD. In other embodiments, a passivation shell layer constitutes at least 16% by weight of the CQD. In further embodiments, a passivation shell layer constitutes at least 17% by weight of the CQD. In additional embodiments, a passivation shell layer constitutes at least 18% by weight of the CQD. In certain embodiments, a passivation shell layer constitutes at least 19% by weight of the CQD. In further embodiments, a passivation shell layer constitutes at least 20% by weight of the CQD. In various embodiments, a passivation shell layer constitutes a % by weight of the CQD in sub-ranges of 15%-17%, 16%-18%, 17%-19%, and 18%-20%. Each sub-range is a separate embodiment.

Without being bound by a particular theory, it is contemplated that a passivation layer having % by weight of the CQD within the ranges disclosed hereinabove, can stabilize the graphitic core and/or affect the optical and electrical properties of the CQD. For example, it is contemplated that a passivation layer can influence the fluorescence properties of the CQD. It is further contemplated that a passivation layer above 15% by weight of the CQD confers superior quantum yields and refractive indices of the CQD. The CQD of the present application is advantageously characterized by enhanced fluorescence and electrical properties compared to hitherto known CQDs. In view of these various enhanced properties, the CQD of the present application is particularly suitable for designing high-RI materials for optoelectronic devices, bioimaging, biosensing, and manipulation of cellular organelles in vivo.

Specifically, the high RI, strong photoluminescence, and controlled particle size of the CQD can enhance light absorption, optical confinement, and emission efficiency, making them advantageous for integration into optoelectronic components. In addition, the recorded QY values and stable fluorescence of the CQD can provide bright, reliable signals that improve imaging contrast while reducing the illumination intensity required for visualization in biological systems. Furthermore, the small, uniform size and biocompatibility of the CQD of the present invention, facilitate their uptake and distribution within cells. The stable luminescence enables real-time optical tracking and targeted interaction with intracellular structures, thereby supporting controlled manipulation of organelles in vivo.

While specific suitable applications of the CQD of the present invention have been detailed herein, it is understood that this is a non-limiting list and the CQD of the present application can be used for other suitable applications.

The CQD disclosed herein may be further characterized in terms of elemental composition of substantially the entire structure of the CQD. The graphitic core and passivation shell layer together substantially comprise the entire structure of the CQD.

In some aspects and embodiments, the CQD of the present invention has a carbon content of at least 63% by weight. In various embodiments, the CQD of the present invention has a carbon content of at least 64% by weight. In certain embodiments, the CQD of the present invention has a carbon content of at least 65% by weight. In other embodiments, the CQD of the present invention has a carbon content of at least 66% by weight. In some embodiments, the CQD of the present invention has a carbon content of at least 67% by weight. In specific embodiments, the CQD of the present invention has a carbon content of at least 68% by weight. In other embodiments, the CQD of the present invention has a carbon content of at least 69% by weight. In certain embodiments, the CQD of the present invention has a carbon content of at least 70% by weight. In some embodiments, the CQD of the present invention has a carbon content of at least 71% by weight. In various embodiments, the CQD of the present invention comprises a % by weight of carbon in a range of 63%-72%, including each value within the specified range. In various embodiments, the CQD has a carbon content within sub-ranges of 63%-66%, 64%-67%, 65%-68%, 66%-69%, 67%-70%, 68%-71%, 69%-72%, and 70%-72%. Each possibility represents a separate embodiment.

The CQD disclosed herein typically comprises at least 15% by weight of nitrogen. In some embodiments, the CQD has a nitrogen content of at least 16% by weight. In other embodiments, the CQD has a nitrogen content of at least 17% by weight. In further embodiments, the CQD has a nitrogen content of at least 18% by weight. In additional embodiments, the CQD has a nitrogen content of at least 19% by weight. In specific embodiments, the CQD has a nitrogen content of at least 20% by weight. In various embodiments, the CQD has a nitrogen content of at least 21% by weight. In exemplary embodiments, the CQD has a nitrogen content of at least 22% by weight. In yet further embodiments, the CQD has a nitrogen content of at least 23% by weight. In particular embodiments, the CQD has a nitrogen content of at least 24% by weight. In some embodiments, the CQD has a nitrogen content of at least 25% by weight.

In some embodiments, the CQD has a nitrogen content within a range of 15%-25% by weight, including each value within the specified range. In various embodiments, the CQD has a nitrogen content within sub-ranges of 15%-18%, 16%-19%, 17%-20%, 18%-21%, 19%-22%, 20%-23%, 21%-24%, and 22%-25%. Each possibility represents a separate embodiment.

Without being bound by any particular theory, it is contemplated that carbonization occurring during the heating of the aqueous medium as disclosed herein, results in formation of the graphitic core of the CQD. It is further contemplated that the passivation shell layer is formed during both the heating of the aqueous medium and during the subsequent gradual and controlled cooling.

In some embodiments, the elemental composition of the CQD is determined using X-ray photoelectron spectroscopy (XPS). In other embodiments, the elemental composition of the CQD is determined using energy-dispersive X-ray spectroscopy (EDS). In further embodiments, the elemental composition may be determined using any other suitable technique.

The CQD of the present invention can be further characterized by its fluorescence emission profile. According to the principles of the present invention, the fluorescence spectrum of the CQD is substantially devoid of an emission peak in the range of about 650 nm to about 700 nm upon excitation at a wavelength in the range of about 320 nm to about 540 nm. The term “substantially devoid” as used herein refers to a fluorescence signal within the specified wavelength range which remains essentially at the baseline (background) level under the stated excitation conditions.

In some embodiments, the fluorescence spectrum is substantially devoid of an emission peak in the sub-range of about 650-660 nm upon excitation at a wavelength in the range of about 320 nm to about 540 nm. In other embodiments, the fluorescence spectrum is substantially devoid of an emission peak in the sub-range of about 660-670 nm upon excitation at a wavelength in the range of about 320 nm to about 540 nm. In further embodiments, the fluorescence spectrum is substantially devoid of an emission peak in the sub-range of about 670-680 nm upon excitation at a wavelength in the range of about 320 nm to about 540 nm. In additional embodiments, the fluorescence spectrum is substantially devoid of an emission peak in the sub-range of about 680-690 nm upon excitation at a wavelength in the range of about 320 nm to about 540 nm. In still other embodiments, the fluorescence spectrum is substantially devoid of an emission peak in the sub-range of about 690-700 nm upon excitation at a wavelength in the range of about 320 nm to about 540 nm. Each possibility represents a separate embodiment.

In each of these embodiments, the excitation wavelength can be within sub-ranges of about 320-360 nm, 360-400 nm, 400-440 nm, 440-480 nm, 480-520 nm, or 520-540 nm, including each value within the specified ranges. Each possibility represents a separate embodiment. In some embodiments, the fluorescence spectra may be measured using a spectrofluorometer. In various embodiments, the measurement of fluorescence spectra may be recorded under excitation wavelengths in the range of about 320 nm to about 540 nm. In certain embodiments, the measurement of fluorescence spectra may be recorded with emission detection in the range of about 350 nm to about 900 nm. In specific embodiments, fluorescence spectra may be obtained using any other suitable fluorescence spectroscopy technique known in the art. In various embodiments, measurements of fluorescence spectra are performed under solution dispersal conditions.

In some embodiments, the CQD has a quantum yield at or above 45%. In other embodiments, the CQD has a quantum yield at or above 50%. In other embodiments, the CQD has a quantum yield at or above 55%. In other embodiments, the CQD has a quantum yield at or above 60%. In other embodiments, the CQD has a quantum yield at or above 65%. In other embodiments, the CQD has a quantum yield in a range of 65% to 90%, including each value within the specified range. In various embodiments, the CQD has a quantum yield within sub-ranges of 45%-50%, 50%-55%, 55%-60%, 60%-65%, 65%-70%, 70%-75%, 75%-80%, 80%-85%, and 85%-90%. Each possibility represents a separate embodiment.

The quantum yield may be determined by methods known in the art, including but not limited to comparing the photoluminescence intensity and absorbance of the CQD to those of a reference fluorophore under identical excitation conditions. In certain embodiments, the quantum yield is measured using a comparative photoluminescence method. In various embodiments, quinine sulfate is used as a reference for the comparative photoluminescence method.

In certain embodiments the CQD has an RI at or above 1.35. In various embodiments, the CQD has an RI at or above 1.4. In other embodiments, the CQD has an RI at or above 1.45. In some embodiments, the CQD has an RI at or above 1.5. In other embodiments, the CQD has an RI at or above 1.55. In particular embodiments, the CQD has an RI at or above 1.6. In some embodiments, the CQD has an RI at or above 1.65. In particular embodiments, the CQD has an RI at or above 1.7. In some embodiments, the CQD has an RI at or above 1.75. In particular embodiments, the CQD has an RI at or above 1.8. In some embodiments, the CQD has an RI at or above 1.85. In some embodiments, the CQD has an RI at or above 1.9. In some embodiments, the CQD has an RI at or above 1.95. In other embodiments, the CQD has an RI at or above 2. In some embodiments, the CQD has an RI at or above 2.05. In some embodiments, the CQD has an RI at or above 2.1. In other embodiments, the CQD has an RI at or above 2.15. In other embodiments, the CQD has an RI in a range of 1.35 to 2.2, including each value within the specified range. In various embodiments, the CQD has a RI within sub-ranges of 1.35-1.4, 1.4-1.45, 1.45-1.5, 1.5-1.55, 1.55-1.6, 1.6-1.65, 1.65-1.7, 1.7-1.75, 1.75-1.8, 1.8-1.85, 1.85-1.9, 1.9-1.95, 1.95-2, 2-2.05, 2.05-2.1, 2.1-2.15, and 2.15-2.2. Each possibility represents a separate embodiment.

In some embodiments, RI is determined using spectroscopic ellipsometry. In other embodiments, RI is determined using refractometry. In further embodiments, RI is determined using any suitable method. In various embodiments, RI is determined for a thin film or dispersion of the CQD under standard conditions of temperature and wavelength. In certain embodiments, RI values are determined for a CQD suspension at one or more illumination wavelengths in the visible spectrum, for example at about 598 nm. The RI may optionally be calculated using optical path delay relationships as known in interferometric techniques.

Fluorescence decay lifetime indicates how long the CQDs spend in an excited state before they return to a ground state through photon emission. A ground state refers to the lowest-energy stable electronic state of a CQD. An excited state refers to an energy state of a CQD in which its electrons possess higher energy than in the ground state.

In certain embodiments, the CQD has a decay time at or above 0.05 ns. In various embodiments, the CQD has a decay time at or above 0.1 ns. In other embodiments, the CQD has a decay time at or above 0.15 ns. In some embodiments, the CQD has a decay time at or above 0.2 ns. In other embodiments, the CQD has a decay time at or above 0.25 ns. In particular embodiments, the CQD has a decay time at or above 0.3 ns. In some embodiments, the CQD has a decay time at or above 0.35 ns. In particular embodiments, the CQD has a decay time at or above 0.4 ns. In some embodiments, the CQD has a decay time at or above 0.45 ns. In particular embodiments, the CQD has a decay time at or above 0.5 ns. In some embodiments, the CQD has a decay time at or above 0.75 ns. In some embodiments, the CQD has a decay time at or above 1.0 ns. In some embodiments, the CQD has a decay time at or above 2.0 ns. In other embodiments, the CQD has a decay time at or above 3.0 ns. In some embodiments, the CQD has a decay time at or above 4.0 ns. In some embodiments, the CQD has a decay time at or above 5.0 ns. In other embodiments, the CQD has a decay time at or above 6.0 ns.

In some embodiments, the CQD has a decay time in a range of 0.05 ns to 8.0 ns, including each value within the specified range. In various embodiments, the CQD has a decay time within sub-ranges of 0.05-0.1 ns, 0.1-0.15 ns, 0.15-0.2 ns, 0.2-0.25 ns, 0.25-0.3 ns, 0.3-0.35 ns, 0.35-0.4 ns, 0.4-0.45 ns, 0.45-0.5 ns, 0.5-0.75 ns, 0.75-1.0 ns, 1.0-2.0 ns, 2.0-3.0 ns, 3.0-4.0 ns, 4.0-5.0 ns, 5.0-6.0 ns, and 6.0-8.0 ns. Each sub-range represents a separate embodiment.

Without being bound by any theory, it is contemplated that the extent of surface passivation can influence the PL decay lifetime of the CQDs, as different functional groups may alter non-radiative pathways and excited-state dynamics. In some embodiments, decay time is determined using time-correlated single photon counting (TCSPC). In other embodiments, decay time is determined using streak-camera-based ultrafast fluorescence lifetime methods. In further embodiments, decay time is determined using any suitable photoluminescence lifetime measurement technique. In various embodiments, decay time is determined for a thin film, suspension, or dispersion of the CQDs under standard conditions of temperature and excitation wavelength. In certain embodiments, decay time values are determined for a CQD suspension at one or more illumination or excitation wavelengths in the visible spectrum, for example at about 360 nm, 400 nm, or 440 nm. The decay time may optionally be calculated using exponential or multi-exponential fitting relationships as known in time-resolved photoluminescence analysis.

In certain aspects and embodiments, there is provided a process of synthesizing a CQD and a CQD obtainable by said process. The process involves the dissolution of the amino acid or nucleotide or metabolite thereof in an aqueous medium followed by heating to a temperature of about 200° C. or higher for a predetermined time period to thereby initiate formation of the CQDs. Finally, the CQDs are recovered following gradual cooling in a controlled manner. The term “gradual cooling” as used herein, refers to cooling the aqueous dispersion of the CQDs at a slow and controlled rate rather than allowing it to cool instantaneously or without regulation. Without being bound by a particular theory, it is contemplated that the gradual cooling in a slow and controlled manner leads to a surface passivation content within the ranges detailed hereinabove.

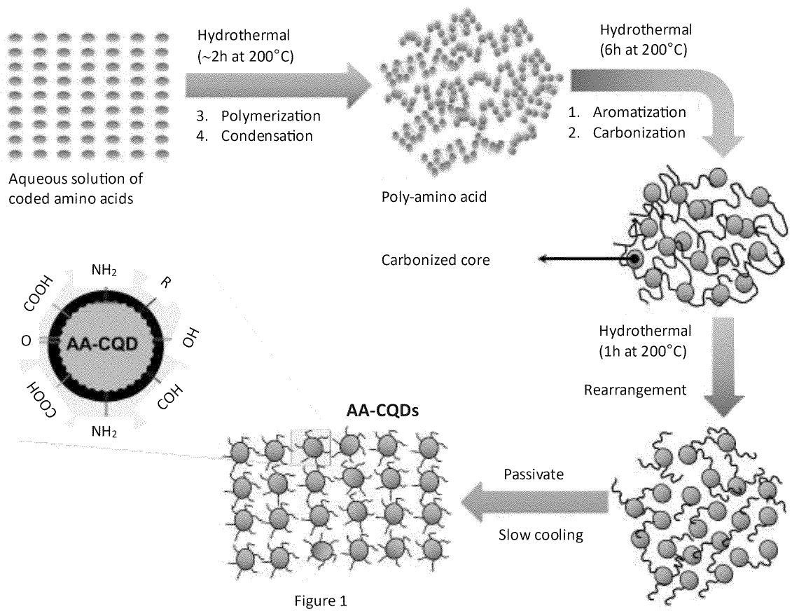

Without being bound by any theory or mechanism of action, it is contemplated that CQD formation proceeds through a sequence of thermally driven transformations occurring during hydrothermal treatment. Reference is now made to FIG. 1, which depicts a schematic illustration of a mechanism by which it is contemplated that the CQDs are formed according to the principles of the present invention. According to the principles of the present invention, synthesis occurs in four stages which include dehydration, polymerization, carbonization and passivation. At the primary stage of hydrothermal treatment, precursor amino acids or nucleotides in the aqueous medium may undergo dehydration and polycondensation reactions, including reactions between carboxyl and amino functionalities in the case of amino acid precursors. As the temperature approaches approximately 200° C., amide species and hydronium ions may form from fragments of the precursor molecules. Continued heating may promote further condensation, dehydration, and dehydrogenation, leading to the formation of polymeric structures. Hydrothermal treatment for approximately 2-3 hours may support polymerization and initial CQD formation, while extended treatment for approximately 6-10 hours at about 200° C. may allow these polymeric intermediates to carbonize and contract, resulting in a nucleation event that yields carbonaceous particles.

With prolonged hydrothermal time, uniform and monodispersed CQDs may be produced, and where amino acids are used, nitrogen may be incorporated into the carbon framework with the level of nitrogen incorporation increasing over time. The resulting carbon core may be surrounded by a shell comprising amino-containing and oxygen-containing surface-passivating groups, and gradual cooling of the reaction mixture may further influence the final extent of surface passivation.

In certain embodiments, an amino acid is dissolved in an aqueous medium to form an aqueous solution. In other embodiments, a nucleotide is dissolved in an aqueous medium to form an aqueous solution. In certain embodiments, the aqueous medium comprises deionized water. In further embodiments, when the method comprises dissolving a nucleotide in an aqueous medium, the method further comprises dissolving a polycarboxylic acid such as citric acid in the aqueous medium. In certain embodiments, the amount of citric acid dissolved in the aqueous medium is equal to at least 2% of the mass of the nucleotide. In other embodiments, the amount of citric acid dissolved in the aqueous medium is equal to at least 3% of the mass of the nucleotide. In further embodiments, the amount of citric acid dissolved in the aqueous medium is equal to 2%-3% of the mass of the nucleotide.

In some embodiments, dissolving an amino acid or a nucleotide is performed at room temperature. In other embodiments, dissolving an amino acid or a nucleotide is performed at elevated temperatures. In various embodiments, the elevated temperature is above 80° C. In some embodiments, the elevated temperature is above 85° C. In some embodiments, dissolving an amino acid or a nucleotide is performed at a temperature in a range of 80° C.-90° C., including each value within the specified range. In some embodiments, dissolving an amino acid or a nucleotide is performed at a temperature in a range of 80° C.-83° C. In other embodiments, dissolving an amino acid or a nucleotide is performed at a temperature in a range of 81° C.-84° C. In further embodiments, dissolving an amino acid or a nucleotide is performed at a temperature in a range of 82° C.-85° C. In certain embodiments, dissolving an amino acid or a nucleotide is performed at a temperature in a range of 83° C.-86° C. In additional embodiments, dissolving an amino acid or a nucleotide is performed at a temperature in a range of 84° C.-87° C. In specific embodiments, dissolving an amino acid or a nucleotide is performed at a temperature in a range of 85° C.-88° C. In various embodiments, dissolving an amino acid or a nucleotide is performed at a temperature in a range of 86° C.-89° C. In some embodiments, dissolving an amino acid or a nucleotide is performed at a temperature in a range of 87° C.-90° C.

In some embodiments, the aqueous solution is heated to a temperature higher than 180° C. In certain embodiments, the aqueous solution is heated to a temperature in a range of 180° C.-220° C. In some embodiments, the aqueous solution is heated to a temperature in a range of 180° C.-185° C. In other embodiments, the aqueous solution is heated to a temperature in a range of 185° C.-190° C. In further embodiments, the aqueous solution is heated to a temperature in a range of 190° C.-195° C. In specific embodiments, the aqueous solution is heated to a temperature in a range of 195° C.-200° C. In yet further embodiments, the aqueous solution is heated to a temperature in a range of 200° C.-205° C. In some embodiments, the aqueous solution is heated to a temperature in a range of 205° C.-210° C. In other embodiments, the aqueous solution is heated to a temperature in a range of 210° C.-215° C. In specific embodiments, the aqueous solution is heated to a temperature in a range of 215° C.-220° C.

In certain embodiments, the heating of the aqueous solution is performed in an autoclave. In some embodiments, the autoclave is a Teflon-lined autoclave. In certain embodiments, the predetermined time period for the heating of the aqueous solution is equal to or longer than 6 hours. In other embodiments, the predetermined time period for the heating of the aqueous solution is equal to or longer than 7 hours. In some embodiments, the predetermined time period for the heating of the aqueous solution is equal to or longer than 8 hours. In other embodiments, the predetermined time period for the heating of the aqueous solution is equal to or longer than 9 hours. In certain embodiments, the predetermined time period for the heating of the aqueous solution is in a range of 6-10 hours, including each value within the specified range. In some embodiments, the predetermined time period for the heating of the aqueous solution is in a range of 6-7 hours. In other embodiments, the predetermined time period for the heating of the aqueous solution is in a range of 7-8 hours. In further embodiments, the predetermined time period for the heating of the aqueous solution is in a range of 8-9 hours. In particular embodiments, the predetermined time period for the heating of the aqueous solution is in a range of 9-10 hours.

In additional embodiments, the gradual cooling of the aqueous solution is performed at a cooling rate of 0.1-10° C./min, including each value within the specified range. In further embodiments, the gradual cooling of the aqueous solution is performed at a cooling rate of 0.1-8° C./min, including each value within the specified range. In other embodiments, the gradual cooling of the aqueous solution is performed at a cooling rate of 0.1-6° C./min, including each value within the specified range. In additional embodiments, the gradual cooling of the aqueous solution is performed at a cooling rate of 0.1-4° C./min, including each value within the specified range. In some embodiments, the gradual cooling of the aqueous solution is performed at a cooling rate of 0.1-2° C./min, including each value within the specified range. In additional embodiments, the gradual cooling of the aqueous solution is performed at a cooling rate of 0.5-1.5° C./min, including each value within the specified range. In further embodiments, the gradual cooling of the aqueous solution is performed at a cooling rate of about 1° C./min. In some embodiments, the gradual cooling is performed in an autoclave in a controlled manner at the specified cooling rates.

The CQDs obtained by the method are typically characterized by a narrow particle size distribution. In some embodiments, the CQD has a diameter which is less than 20 nm. In other embodiments, the CQD has a diameter which is less than 15 nm. In certain embodiments, the CQD has a diameter which is less than 10 nm. In further embodiments, the CQD has a diameter in a range of 2-20 nm, including each value within the specified range. In further embodiments, the CQD has a diameter in a range of 2-10 nm, including each value within the specified range. In various embodiments, the CQD has a diameter within sub-ranges of 2 nm-3 nm, 3 nm-4 nm, 4 nm-5 nm, 5 nm-8 nm, 6 nm-9 nm, 7 nm-10 nm, 8 nm-11 nm, 9 nm-12 nm, 10 nm-13 nm, 11 nm-14 nm, 12 nm-15 nm, 13 nm-16 nm, 14 nm-17 nm, 15 nm-18 nm, 16 nm-19 nm, and 17 nm-20 nm. Each possibility represents a separate embodiment.

In some embodiments, the CQD is substantially spherical. The term “substantially spherical” as used herein, refers to a particle morphology in which a ratio of the longest particle dimension to the shortest particle dimension (aspect ratio) is about 1. The term “diameter” as used herein, refers to the characteristic particle size of the CQD, including an effective or average particle diameter for embodiments involving nonspherical CQDs. In some embodiments, the diameter refers to an average particle size determined for a population of CQDs using any suitable particle-size analysis technique.

In certain embodiments, the CQDs exhibit a narrow particle size distribution. The term “narrow particle size distribution” as used herein refers to a distribution wherein more than 90% of the particles have a particle size in the range of 0.2-2 times the mean (or average) particle size. Preferably, more than 95% of the particles have a particle size within this range. Even more preferably, more than 99% of the particles have a particle size within this range. Thus, for example for a mean particle size of 5 nm, a narrow size distribution refers to a distribution wherein more than 90%, 95% or 99% of the particles have a particle size in the range of 1-10 nm. Each possibility represents a separate embodiment. In some embodiments, the majority of the CQDs fall within a tightly constrained range relative to the average diameter of a population of CQDs.

In some embodiments, the particle diameter may be determined using transmission electron microscopy (TEM). In other embodiments, the particle diameter may be determined using atomic force microscopy (AFM), dynamic light scattering (DLS), or any other suitable technique known in the art.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either or both of those included limits are also included in the invention.

The term “about” as used herein refers to ±10% of a specified value.

“Room temperature” as used herein refers to 25° C.±20%.

Throughout the description and claims, the words “comprise” and “contain” and variations of the words, for example “comprising” and “comprises”, mean “including but not limited to”, and are not intended to (and do not) exclude other moieties, additives, components, integers or steps.

As used herein, the singular forms “a”, “an”, and “the” include plural forms unless the context clearly dictates otherwise. Thus, for example, reference to “a passivation shell layer” also includes a plurality of passivation shell layers.

As used herein, the term “and” or the term “or” include “and/or” unless the context clearly dictates otherwise.

In those instances where a convention analogous to “at least one of A, B, and C, etc.” is used, in general such a construction is intended in the sense one having skill in the art would understand the convention (e.g., “a composition having at least one of A, B, and C” would include but not be limited to compositions that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B”.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination. All combinations of the embodiments pertaining to the invention are specifically embraced by the present invention and are disclosed herein just as if each and every combination was individually and explicitly disclosed. In addition, all sub-combinations of the various embodiments and elements thereof are also specifically embraced by the present invention and are disclosed herein just as if each and every such sub-combination was individually and explicitly disclosed herein.

The following examples are presented in order to more fully illustrate certain embodiments of the invention. They should in no way, however, be construed as limiting the broad scope of the invention. One skilled in the art can readily devise many variations and modifications of the principles disclosed herein without departing from the scope of the invention.

### EXAMPLES

### Materials and Methods

### Materials

Quinine sulfate (98.0%), canavanine, and all 20 proteinogenic amino acids (AAs) (arginine, histidine, lysine, aspartic acid, glutamic acid, serine, threonine, asparagine, glutamine, cysteine, glycine, proline, alanine, valine, isoleucine, leucine, methionine, phenylalanine, tyrosine, tryptophan) were purchased from Sigma-Aldrich Co., Ltd. at a purity level greater than 99.0% and used with no further purification. The nucleotides were used at a purity level of 99.0% and were mixed with 2-3 weight % of citric acid (98% purity) for hydrothermal reaction to produce the nucleotide-based CQDs.

### Methods

### Synthesis of Water Soluble CQDs

The CQDs were synthesized using a modified hydrothermal method. The hydrothermal method is described in Kumar et al. (A Hydrothermal Reaction of an Aqueous solution of BSA Yields Highly Fluorescent N Doped C-Dots Used for Imaging of Live Mammalian Cells. J. Mater. Chem. B 2016, 4 (17), 2913-2920), which is incorporated herein by reference. Briefly, each AA was dissolved separately in 20 mL of deionized water to avoid cross contamination. The deionized water with the dissolved AAs, was then transferred to a 50 mL Teflon-lined autoclave and heated at 200° C. for 6-10 hours in a hot air oven. Then, slow cooling with a controlled cooling rate of 1° C./min. is performed. In most cases, a dark yellow-brown liquid was obtained when the temperature in the autoclave reached 25° C. A small amount of carbide slag was removed from the product solution by Millipore filtration (0.22 μm). The solution was then dialyzed with DIW using Amicon® Ultra-15 Centrifugal Filter Units (MWCD=2000 Da) to remove the unreacted AAs. The resulting aqueous suspensions of nitrogen (N)-containing AA-CQDs were then evaluated for fluorescence, refractive index (RI), decay time, physical morphology, chemical behavior, cell viability, and live cell imaging.

### Physiochemical Characterizations

Visual analysis, fluorescence, ultraviolet visible (UV-VIS) absorption, fluorescence decay time, and transmission electron microscopy (TEM) studies were carried out in order to characterize the CQDs that were formed from the aqueous solutions of AAs.

After the CQDs materials were dried using lyophilization, an X-ray photoelectron spectroscopy (XPS) analysis was conducted using an SCALAB QXi X-ray Photoelectron Spectrometer Microprobe with a monochromatic X-ray source (Micro-focused dual-anode Al K-α and Ag L-α source) with Al Kα excitation (1486.6 eV), and C 1s as the reference energy (EC 1s=284.0 eV).

### Fluorescence Properties, QY and PL Decay Lifetime Characterizations

To determine excitation-dependent fluorescence properties of each of the AA-CQDs, fluorescence spectroscopy measurements were performed. 2 mL of sample solution were pipetted into a four-sided transparent quartz cuvette with a path length of 10 mm, at ambient temperature, and the spectra were collected using a FluoroMax-4 Spectrofluorometer (Horiba Jobin Yvon, Kyoto, Japan). The effect of each of the 20 AA residues in diversely functionalized AA-CQDs was studied at excitation and emission wavelengths which were set at 320-540 nm and 350-900 nm, respectively, each with a 2 nm slit width. The AA-CQDs were analyzed with a spectrophotometer (Varian Cary 100) under ultraviolet (UV) light. As a control, fluorescence of pristine AAs in aqueous solutions was measured.

Quantum Yields (QYs) of all AA-CQDs were determined by comparing their photoluminescence (PL) intensities (excited at 360 nm) and absorbance values (at 360 nm) to that of quinine sulfate (QS) in a 0.1 mM H₂SO₄ solution (QY=54%). All AA-CQDs and QS PL emission spectra were recorded at 360 nm to determine an integrated fluorescence intensity, which is defined as the area under the PL curve over the wavelength range of 370 to 700 nm. Subsequently, the integrated fluorescence intensity was plotted against the absorbance value. In order to calculate QY values, the following equation was used:

$$QY = {QY}_{QS} \frac{{A}_{CQD}}{{A}_{QS}} \times \frac{{PL}_{QS}}{{PL}_{CQD}} \times \frac{{{n}^{2}}_{CQD}}{{{n}^{2}}_{QS}} \times 100 \% \qquad Equation [ 1 ]$$

where QY is the fluorescence quantum yield, A is the absorbance, PL is the fluorescence emission peak, and n is the RI where the RI of the quinine sulphate is 1.33. To reduce the effects of re-absorption, absorbance was kept below 0.1 optical density (OD) in a 10 mm quartz cuvette. The fluorescence QYs of the AA-CQDs were estimated by comparing the integrated PL intensity (excited at 360 nm) and absorbance values (at 360 nm) to that of QS in a 0.1 mM H₂SO₄ solution (QY=54%).

AA-CQD suspensions were placed in quartz cuvettes and the fluorescence/PL decay time was measured using a FluoroMax-4 Spectrofluorometer (Horiba Jobin Yvon, Kyoto, Japan), which is equipped with double monochromators, a 450 W Xe lamp, an AGILE source, time-correlated single photon counting capability, a standard cuvette holder, and a standard PMT-900 detector. Fluoracle's standard option for acquiring decay times based on excitation provides automatic acquisition of decay times based on excitation. A standard streak camera (Hamamatsu) was used in conjunction with a femtosecond laser excitation source able to produce several wavelengths of excitation to measure the excitonic decay lifetime of all twenty AA-CQDs. Time-resolved PL was measured at wavelengths of 400 and 440 nm.

### Refractive Index Measurements

The RI values of the AA-CQD suspensions were determined using a refractometer (ATAGO, PAL-RI) for a single wavelength of 598 nm and interferometric phase microscopy (IPM) for 8 different illumination wavelengths across the visible spectrum. For the IPM technique, the solutions were inserted into a 100 μm tall microfluidics channel (Ibidi, μ-Slide VI 0.1), and fluorescence microscopy imaging was performed to verify that the fluorescent AA-CQD suspension (fully transparent with no precipitation) had filled the channel. Next, off-axis holograms of the channel filled with the suspension were acquired using a shearing IPM system and a supercontinuum laser source (NKT SuperK EXTREME) coupled to an acousto-optical filter (NKT SuperK SELECT), thereby enabling acquisition of holograms with 8 different illumination wavelengths (490, 500, 515, 530, 620, 641, 650, and 680 nm). Additionally, background holograms of the channel containing only water were acquired for each wavelength. Following this, optical path delay (OPD) maps of the channel filled with each sample suspension and illuminated with each wavelength were reconstructed from their respective holograms, while using the corresponding background holograms to negate the OPD contribution of the water in the suspension. The OPD of a sample at a given point (x,y) and for an illumination wavelength 2 is defined by:

$$OPD ( x , y , λ ) = [ {n}_{s} ( x , y , λ ) - {n}_{m} ( x , y , λ ) ] h ( x , y ) \qquad Equation [ 2 ]$$

where nₛ is the RI of the sample, nₘ is the RI of the surrounding medium (i.e., the medium of the background hologram), and h is the sample height. By rearranging the equation, the RI of the suspension, nₛ was determined using the average OPD value of the channel in each hologram:

$${n}_{s} ( x , y , λ ) = \frac{OPD ( x , y , λ )}{h ( x , y )} + {n}_{m} ( x , y , λ ) \qquad Equation [ 3 ]$$

where h is the known channel height, 100 μm, and nₘ is the known RI of water for each wavelength (Hale et al., Optical Constants of Water in the 200-nm to 200-μm Wavelength Region. Appl. Opt. 1973, 12 (3), 555). Finally, the RI of the suspended AA was determined using the Lorentz-Lorentz mixture rule as follows:

$$\frac{{{n}_{s}}^{2} - 1}{{{n}_{s}}^{2} + 2} = {ϕ}_{1} \frac{{{n}_{s}}^{2} - 1}{{{n}_{s}}^{2} + 2} + {ϕ}_{2} \frac{{{n}_{s}}^{2} - 1}{{{n}_{s}}^{2} + 2} \qquad Equation [ 4 ]$$

where n₁ and φ₁ are the RI and the volume fraction of the suspended AA, respectively, and n₂ and φ₂ are the RI and the volume fraction of the suspension medium, respectively. The volume fractions were calculated using the known sample concentrations of the AA-CQDs density, and the values of n₂ are identical to nₘ as detailed hereinabove.

### In-Vitro Cytotoxicity and Cellular Imaging Using the AA-CQDs

A methyl thiazolyl tetrazolium (MTT) assay was performed using human cervical carcinoma cells (HeLa cells) to assess the cytotoxicity of AA-CQD nanomaterials. The cells were seeded into 96-well microtiter plates and allowed to adhere overnight at 37° C. under 5% CO₂. Following 24 hours of HeLa cell growth, all cell culture media were removed, and the cells were treated with AA-CQD nanomaterials without FBS (fetal bovine serum) medium. The cells were then washed with 7.4 pH phosphate buffer solution (PBS) and incubated with MTT solution for 3.5 hours. Subsequently, the MTT reagent was discarded, and 100 μL of DMSO was added to each well to dissolve the formazan crystals. The absorbance was measured at 570 and 680 nm using a microplate reader. Control experiments were conducted without AA-CQD nanomaterials. The experiments were conducted in quadruplicate.

Following the cytotoxicity assays, live cell bioimaging capabilities of the most fluorescent AA-CQDs (QY>45%) were examined. Specifically, live cell bioimaging capabilities of His-CQDs, Arg-CQDs, Lys-CQDs, Thr-CQDs, Ser-CQDs, Asp-CQDs, and Pro-CQDs were examined. Live cell imaging of Hela cells was conducted using confocal microscopy after the cells were grown in glass bottom petri dishes. HeLa cells were cultured in high glucose media for two days, then 100 μg/mL of AA-CQDs were added into the cell culture media and incubation was continued for varying lengths of time (2 h, 6 h and 24 h). The imaging was performed using an SP8 inverted confocal microscope (Leica Microsystems, Wetzlar, Germany) in conjunction with Hoechst dye for nucleus localization. The excitation and emission ranges were as follows: λₑₓ=480 nm, 543 nm, 630 nm, and λₑₘ=500-580 nm, 560-630 nm, and 650-740 nm, respectively.

### Example 1—Physiochemical Characterizations of AA-CQDs

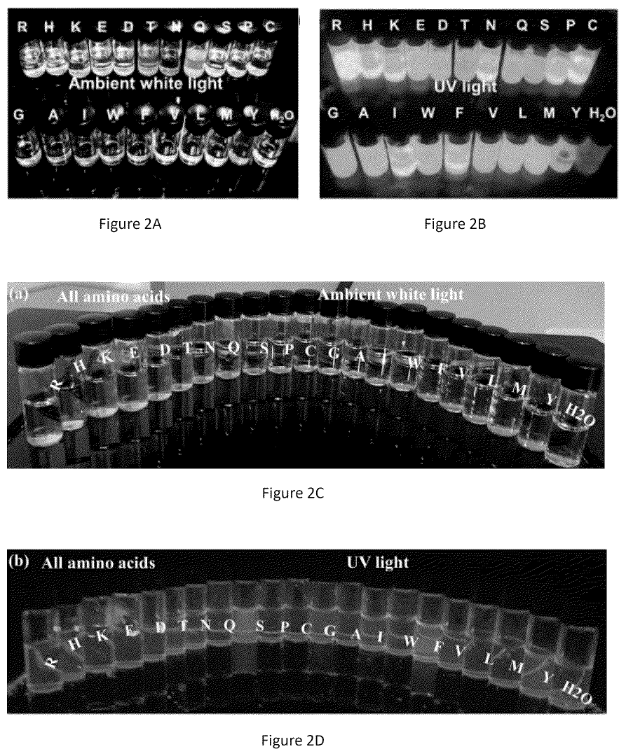

Visual inspections were performed of aqueous suspensions of CQDs synthesized from AAs under modified hydrothermal conditions, and of aqueous suspensions of pristine AAs, in ambient white light and ultraviolet (UV) light. Light pale-yellow to dark pale-yellow were the predominant colors of the synthesized CQDs in ambient white light as shown in FIG. 2A. The corresponding aqueous suspensions of pristine AAs were predominantly colorless, as shown in FIG. 2C. Under UV light (365 nm), the aqueous suspensions of AA-CQDs exhibited a blue-white to green-white fluorescence as shown in FIG. 2B, and the aqueous suspensions of pristine AAs exhibited no fluorescence under the same UV light as shown in FIG. 2D. The fluorescence of each of the suspensions did not change after prolonged exposure to UV light or to white light.

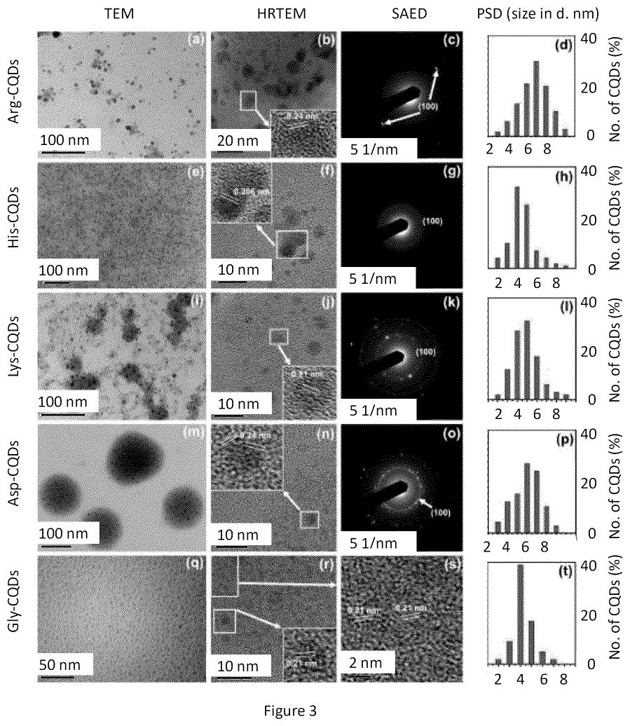

Transmission electron microscopy (TEM) and high-resolution TEM (HR-TEM, JEOL 2100) were used to examine the morphologies of synthesized AA-CQDs. To determine crystallographic information of the synthesized AA-CQDs, selected area electron diffraction (SAED) was used (FIG. 3).

TEM images for Arg-CQDs show uniform spherical particles. In addition, HRTEM analysis showed that the Arg-CQDs had clear lattice fringes, with 0.21 nm d-spacing, indicating that Arg-CQD particles are highly crystalline. The SAED pattern of Arg-CQDs was found to display the ring pattern of graphitic diffraction of a sp² structure with (100) planes.

TEM images for His-CQDs show mostly spherical and generally well-dispersed particles. HRTEM images and SAED patterns of His-CQD particles show a d-spacing of 0.206 nm and the (100) planes.

TEM and HRTEM images for Lys-CQDs show uniform and monodispersed particles with a near-spherical shape and an interlayer spacing of approximately 0.21 nm, a morphology indicative of the formation of graphite structures.

TEM images of Asp-CQDs and Gly-CQDs show uniform and monodispersed particles with near-spherical shapes. HRTEM images and SAED patterns of the Asp-CQDs and Gly-CQDs revealed their crystalline nature with an interlayer spacing of 0.24 nm and 0.21 nm, respectively, indicating that graphite structures had been formed. TEM images for the other AA-CQDs were also obtained.

A purity analysis was conducted on His-CQDs using energy-dispersive X-ray spectroscopy (EDS). His-CQDs were found to contain C, N, and O, indicating that the sample did not contain any impurities. Table 1 below summarizes average particle sizes of each of the AA-CQDs (also depicted in FIG. 3 for Arg-CQDs, His-CQDs, Lys-CQDs, Asp-CQDs, and Gly-CQDs), as well as other measurements which will be elaborated on hereinbelow.

TABLE 1
Measured properties of all AA-CQDs

| | | | | | | | | Cell |
|---|---|---|---|---|---|---|---|---|
| | | | | | | | | viability |
| | | | Intensity | | Decay | Average | | at 100 |
| | | | at λₑₘ | QY | time | Size | | μg/mL |
| Type | λₑₓₜ | λₑₘ | [M] | (%) | (ns) | (nm) | RI | (%) |
| Arg-CQDs | 400 | 460 | 15.41 | 86 | 7.99 | 7 | 2.152 | 83 |
| His-CQDs | 360 | 443 | 14.56 | 81 | 4.46 | 4.5 | 2.042 | 96 |
| Lys-CQDs | 400 | 468 | 15.4 | 76 | 4.67 | 5 | 1.756 | 97 |
| Glu-CQDs | 380 | 451 | 13.83 | 45 | 4.9 | 5 | 1.561 | 90 |
| Asp-CQDs | 340 | 412 | 6.04 | 26 | 4.19 | 6.5 | 1.642 | 98 |
| Thr-CQDs | 460 | 503 | 8.709 | 75 | 4.98 | 5.4 | 1.784 | 97 |
| | | 557 | 8.694 | | | | | |
| Asn-CQDs | 380 | 448 | 14.71 | 50 | 5.67 | 7.5 | 1.749 | 82 |
| Gln-CQDs | 360 | 440 | 11.97 | 59 | 5.38 | 7 | 1.67 | 84 |
| Ser-CQDs | 460 | 553 | 7.121 | 72 | 5.46 | 6 | 1.548 | 88 |
| Pro-CQDs | 380 | 446 | 15.44 | 68 | 6.56 | 5 | 1.805 | 98 |
| Cys-CQDs | 440 | 523 | 8.35 | 51 | 5.16 | 8 | 1.657 | 80 |
| Gly-CQDs | 400 | 459 | 15.47 | 73 | 6.06 | 4.5 | 1.592 | 95 |
| Ala-CQDs | 460 | 481 | 14.44 | 49 | 5.18 | 5.5 | 1.719 | 97 |
| Ile-CQDs | 340 | 417 | 4.829 | 17 | 3.85 | 4.5 | 1.688 | 88 |
| Trp-CQDs | 380 | 458 | 1.645 | 57 | 0.17 | 6 | 1.673 | 86 |
| Phe-CQDs | 380 | 449 | 15.43 | 46 | 4.02 | 7 | 1.632 | 90 |
| Val-CQDs | 360 | 436 | 7.264 | 24 | 3.19 | 4.5 | 1.601 | 93 |
| Leu-CQDs | 360 | 418 | 8.484 | 23 | 2.96 | 5 | 1.595 | 95 |
| Met-CQDs | 400 | 458 | 14.01 | 47 | 0.09 | 5 | 1.397 | 87 |
| Tyr-CQDs | 360 | 450 | 1.287 | 16 | 0.19 | 6 | 1.389 | 94 |

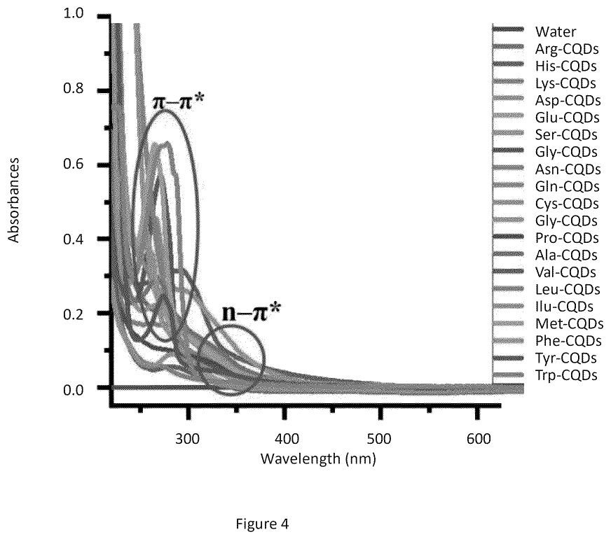

UV-VIS spectroscopy was used to reveal different characteristics of AA-CQD absorption peaks. Three distinct absorption peaks were observed in the UV-VIS spectra of the AA-CQDs as shown in FIG. 4, suggesting that the AAs were efficiently conjugated to the surface of the CQDs and formed long-chain polyamides and polyesters. The spectra indicate that the long-chain polyamides and polyesters assembled and provided a supramolecular, polymeric, and compact structure, which exhibited a sharp high-energy absorption peak at 235 nm and a broad low-energy absorption peak around 340 nm which were assigned to the electronic transition from π to π* of the sp² hybridized carbon-heteroatom bond (C═O and C═N). In addition, the absorption band around 260-270 nm corresponds to the AAs. The absorbances of coded AA-derived CQDs at 240 and 340 nm were associated with some of the self-assembled AAs on the surface of CQDs. The absorption peaks at 270 and 360 nm were detected in the absorption spectra of all AA-CQDs with high-energy (π−π*) and low-energy (n−π*) electron transitions, respectively (FIG. 4). The UV-VIS absorption spectra indicate that the supramolecular, compact, polymeric, assembled molecular structure attached to AAs exhibits tunable optical properties.

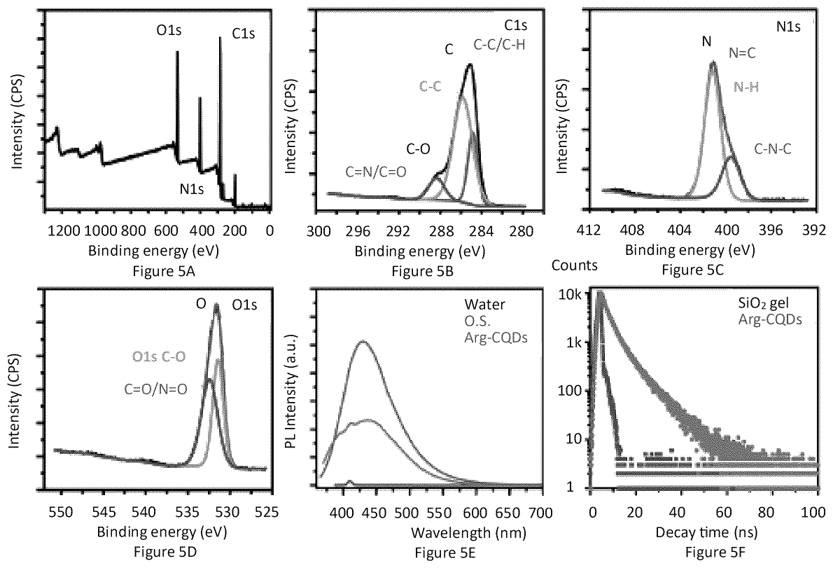

XPS analysis confirmed that the CQDs were indeed doped with N. FIGS. 5A-5D show that carbon, nitrogen, and oxygen were present in the AA-CQD, with the presence of C 1s (65.8%), N 1s (17.5%), and O 1s (15.7%). As shown in FIG. 5A, binding energy peaks were observed at 284, 399, and 531 eV, corresponding to the typical XPS survey peaks at C 1s, N 1s, and O 1s, respectively. A high-resolution C Is spectrum is shown in FIG. 5B, with peaks at 284.6, 285.7, 286.1, and 288.8 eV representing C═C, C—C, C—O/C—N, and C—O/C═N bonds, respectively. Based on the high-resolution N Is spectrum, the binding energy peak at 399.9 eV indicated that pyridinic N was the dominant state (FIG. 5C). It is contemplated that some N was doped in defect areas or near the edges of graphitized carbon structures of the AA-CQDs. According to FIG. 5D, the two peaks at 531.6 and 533.1 eV in the O Is high-resolution spectrum represented C—O and C═O, respectively. There are slight differences in the percentages of the three elements in each of the 20 AA-based CQDs, with a higher amount of N in His-CQDs and Arg-CQDs compared to other AA-CQDs. High amounts of oxygen-containing functional groups (such as carboxyl groups) would cause large fluctuations in the optical properties of AA-CQDs. In addition, closer examination of the XPS analysis can reveal a significant degree of polarization due to the carboxyl groups, whose rotation relative to the basal plane affected the degree of polarization. Therefore, it is contemplated that the oxygen content may be a result of the oxygen functional groups present in AA-based CQDs and may also be responsible for affecting the RI of AA-CQDs.

### Example 2—Fluorescence Properties, QY and PL Decay Lifetime Characterizations of AA-CODs

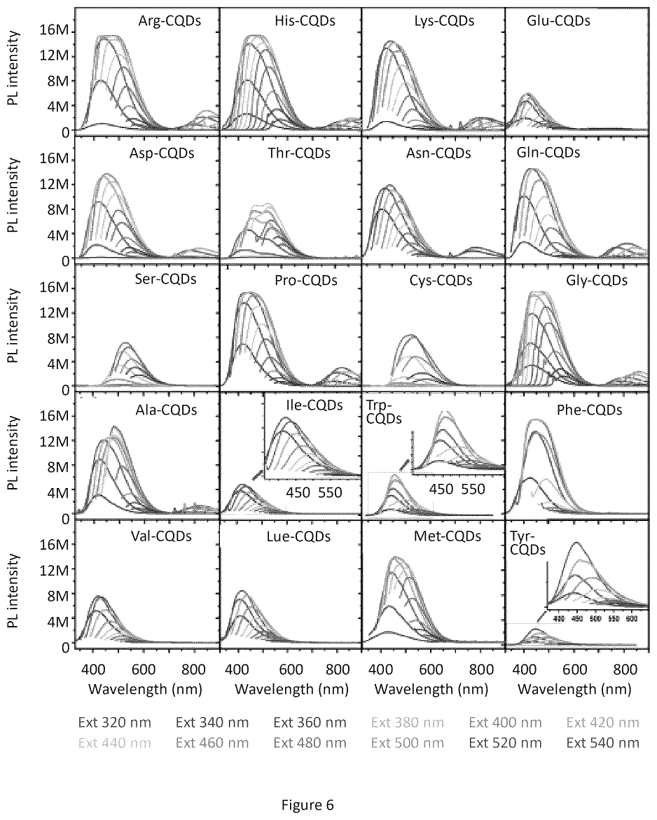

Comparative fluorescence spectra of all the AA-CQDs are shown in FIG. 6. The AA-CQDs exhibited extremely high fluorescence compared to pristine AA molecules. It was observed that molecular fluorophores produced excitation-dependent emission that remained on the surface of the AA-CQDs at both the core and the defect sites. Specifically, the highest fluorescence was observed for Arg-CQDs, His-CQDs, Lys-CQDs, Asp-CQDs, Asn-CQDs, Gly-CQDs, Pro-CQDs, and Met-CQDs. In particular, excitation at 340-360 nm produced a highly intense emission spectrum at 400-450 nm for His-CQDs, Asp-CQDs, Gln-CQDs, Ile-CQDs, Val-CQDs, Leu-CQDs, and Tyr-CQDs. Additionally, upon excitation between 440 and 480 nm, high emissions between approximately 500 and 600 nm were observed for CQDs such as Thr-CQDs, Ser-CQDs, Cys-CQDs, and Ala-CQDs. The Thr-derived CQDs exhibited a different fluorescence pattern compared to the other 19 AA-CQDs, with two emission peaks at 505 and 560 nm instead of one emission peak at 460 nm. The two emission peaks may also represent two photonic states of the material. Low fluorescence was observed for Ile-CQDs, Val-CQDs, Leu-CQDs, Tyr-CQDs, and Trp-CQDs.

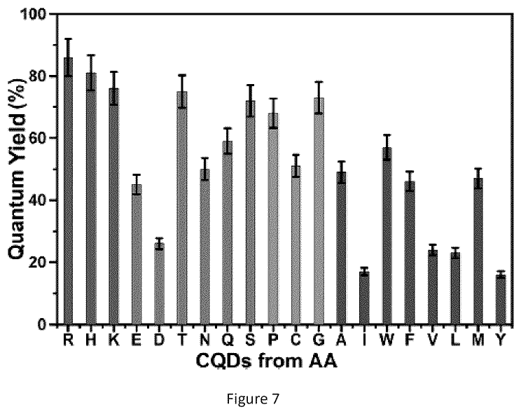

QY values for the AA-CQDs were obtained using equation [1]. The highest QY values were found to be 86%, 81%, 76%, 75%, 72%, 68%, and 73% for Arg-CQDs, His-CQDs, Lys-CQDs, Thr-CQDs, Ser-CQDs, Pro-CQDs, and Gly-CQDs, respectively. QY values for all AA-CQDs are included in Table 1 hereinabove, and graphically represented in FIG. 7. A higher QY was observed for CQDs containing AAs with a positive charge compared with hydrophilic AAs. The long-chain polymer network formed a supramolecular self-assembled structure conducive to hydrophobic interactions, which is a key component of tunable optical properties. In addition, a correlation was shown between side chain volume effects and emissivity of the AA-CQDs, and it was found that as the side chain volume increased, the QY also increased. Notably, it was observed that a higher percentage of heteroatoms (O, N, and S) in the CQDs correlated to a higher photoluminescence QY, of up to 86% (Arg-CQDs). These results indicate that heteroatoms play an important role in emission and improve the QY of AA-CQDs.

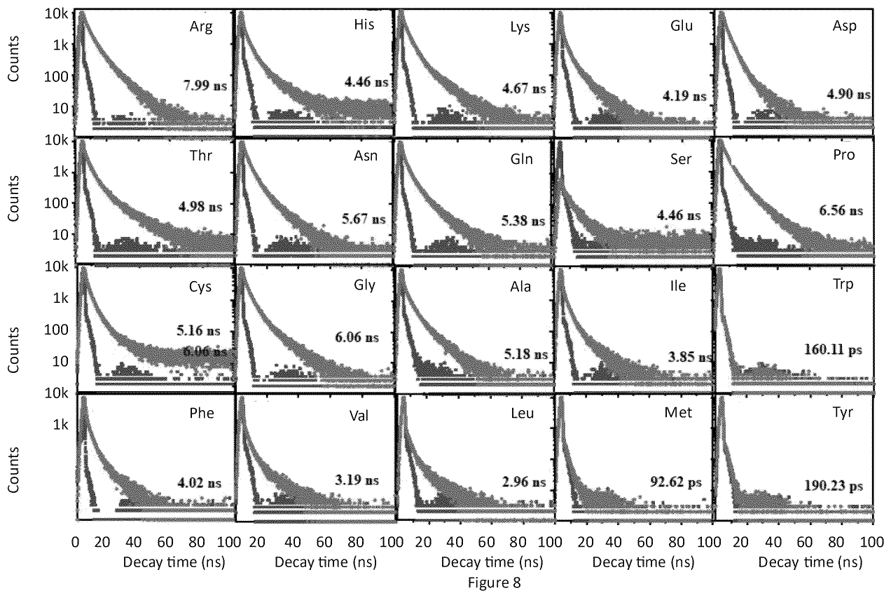

PL decay lifetimes varied according to the passivation degree of the AA on the surface of the CQD, which was determined by the different functional groups of each AA. Comparatively, the Arg-CQDs exhibited the longest PL decay lifetime of 7.99 nₛ, presumably due to exhibiting the highest degree of amino passivation on surfaces thereof. FIG. 8 shows graphical representations of all AA-CQD decay times, which are also recorded in Table 1.

### Example 3—Refractive Index Measurements

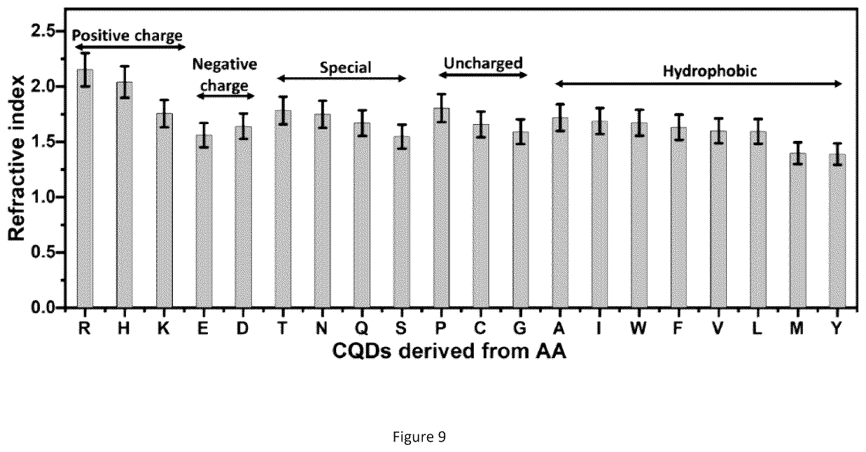

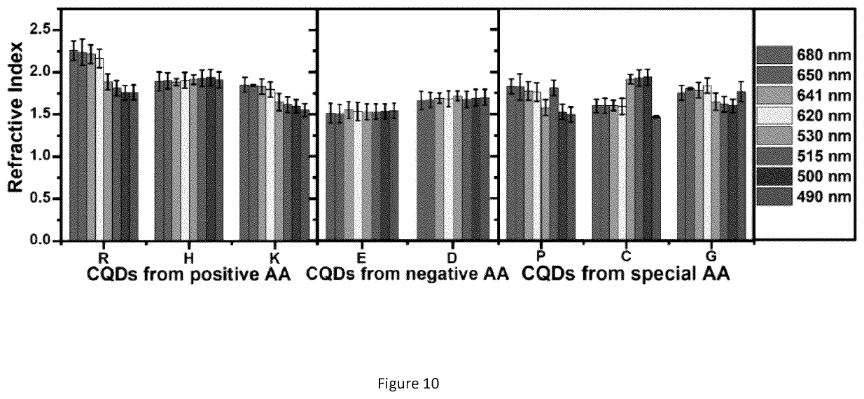

As detailed hereinabove, the RI values of the AA-CQD suspensions were determined using a refractometer (ATAGO, PAL-RI) for a single wavelength of 598 nm and interferometric phase microscopy (IPM) for 8 different illumination wavelengths across the visible spectrum. Additionally, equations [2], [3], and [4] were used to calculate RI values of the AA-CQD suspensions. It was found that the AA-CQDs possessed high RIs (>1.70), with RIs of 2.15 for Arg-CQDs, 2.04 for His-CQDs, 1.76 for Lys-CQDs, 1.79 for Thr-CQDs, 1.81 for Pro-CQDs, 1.75 for Asn-CQDs, and 1.72 for Ala-CQDs. RI values of all AA-CQDs are graphically represented in FIG. 9, grouped by charge, hydrophobicity, polarity, and aromaticity and are additionally recorded in Table 1. Additionally, using the IPM technique, RI values were determined for all 20 AA-CQDs for illumination wavelengths of 490, 500, 515, 530, 620, 641, 650, and 680 nm. The RI values for the AA-CQDs at each of these wavelengths are graphically represented in FIG. 10. A control experiment determined RIs of all 20 pristine AAs which were found to be <1.56.

Without being bound by any theory or mechanism of action, it is contemplated that the AA-CQDs possessing high RI enable to control multipole moments and are able to effectively concentrate electromagnetic energy. Furthermore, the formation of high-quality colloidal AA-CQD crystals would result in optical diffraction at wavelengths based on the size of the sphere (or cavity) and the surface functionality, which also affects the RI of the materials. According to refractometer measurements and phase change measurements, Arg-CQDs, His-CQDs, Lys-CQDs, Pro-CQDs, and Thr-CQDs exhibit very high RI that is not obtained in all AA-CQDs. The high RI AA-CQDs provide the excitation of Mie resonances which can be used to match windows of relative biological transparency (480-900 nm), which can also be applied to attractive theranostics applications. Furthermore, the HRTEM analysis of the synthesized AA-CQDs indicates a significantly high degree of crystallization and compactness.

### Example 4—In-Vitro Cytotoxicity and Cellular Imaging Using the AA-CQDs

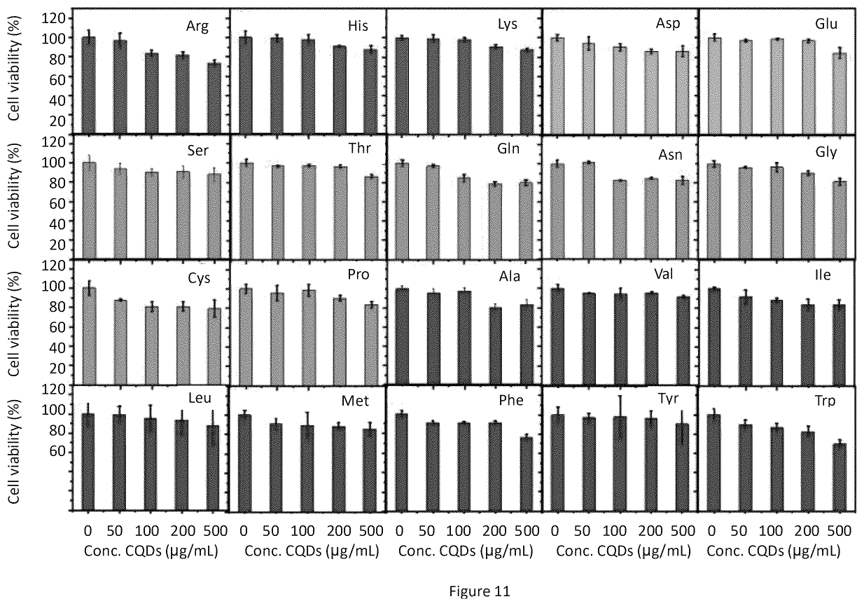

A methyl thiazolyl tetrazolium (MTT) assay was performed using human cervical carcinoma cells (HeLa cells) to assess the cytotoxicity of AA-CQDs as detailed hereinabove. The assays showed that over 95% of the cells survived after a 24-hour treatment with AA-CQDs at a concentration of 100 μg/mL, indicating excellent biocompatibility. Cell viability measurements of each of the AA-CQDs are shown in FIG. 11 and are additionally recorded in Table 1.

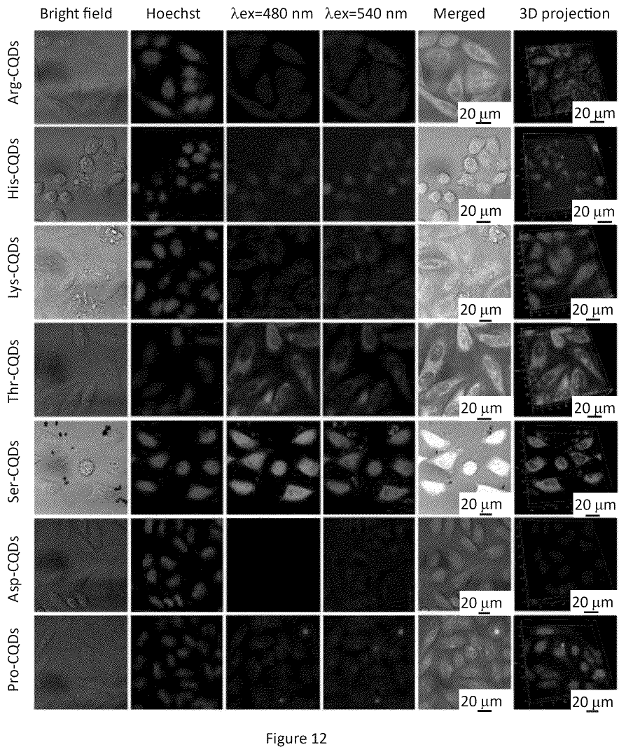

Following the cytotoxicity assays, live cell bioimaging capabilities were examined, of the most fluorescent AA-CQDs (QY>45%): His-CQDs, Arg-CQDs, Lys-CQDs, Thr-CQDs, Ser-CQDs, Asp-CQDs, and Pro-CQDs. Live cell imaging of Hela cells was conducted using confocal microscopy as detailed hereinabove. As shown in FIG. 12, AA-CQD fluorescence was observed residing within the cytoplasm, near the nuclear membrane, and partially within the nucleus.

These results indicate that Thr-CQDs, Ser-CQDs, Arg-CQDs, Lys-CQDs, and His-CQDs can be excellent agents for targeted nuclear membrane tracking and partial nuclear penetration. The AA-CQDs display fluorescence at three fluorescence channels, with λₑₓ=405, 480, 540 nm and λₑₘ=420-470, 500-580, and 560-630 nm, respectively. Specifically, three fluorescence excitation channels, 405, 480, and 540 nm, displayed enhanced performance. It was found that depending on the surface composition, the AA-CQDs could target the nucleus and cross the nuclear membrane. According to the above cellular analysis, it was observed that positively charged AA-CQDs and polar uncharged AA-CQDs are advantageous for cellular imaging due to their high fluorescence and QYs, as well as their high RI.

### Example 5—CQDs Derived from Nucleotides and N-Containing Metabolites

In addition to the proteinogenic AA-CQDs, CQDs were synthesized from the non-proteinogenic AA canavanine as well as from adenine, uracil, thymine, cytosine, and guanine nucleotides in the presence of citric acid using the modified hydrothermal process which is outlined hereinabove.

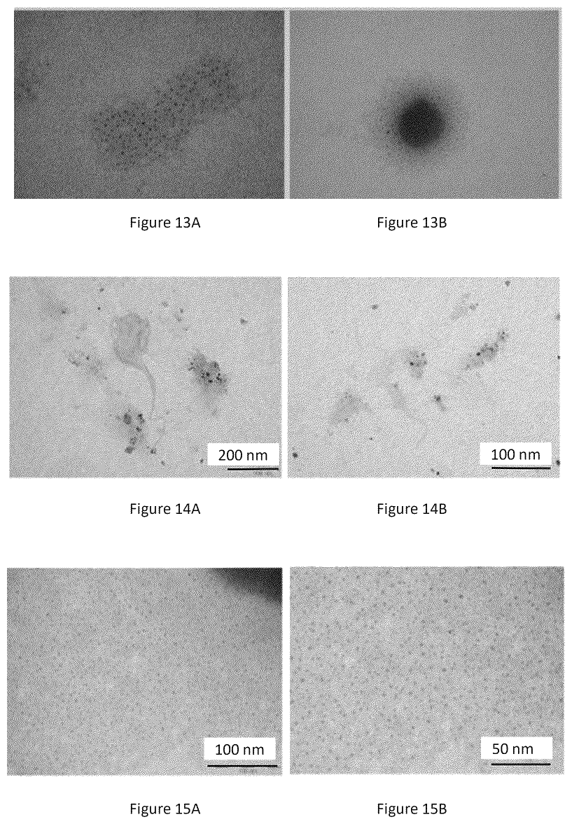

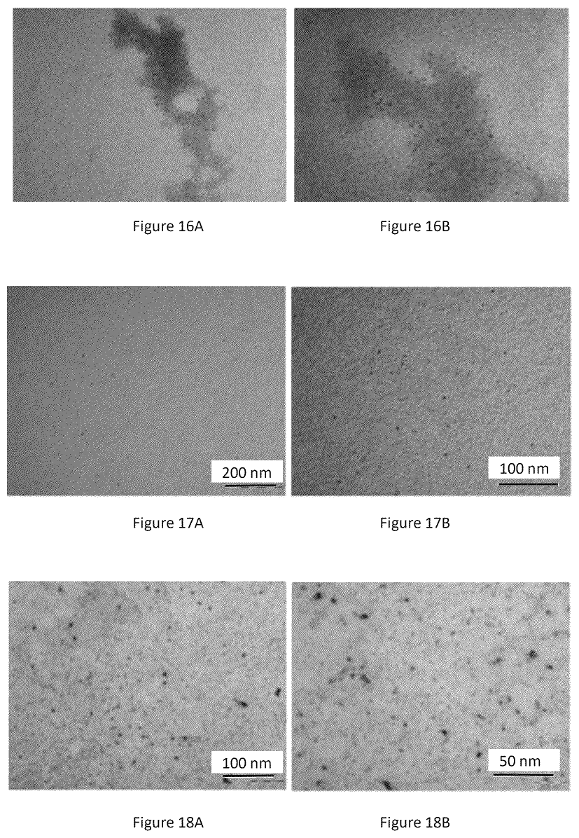

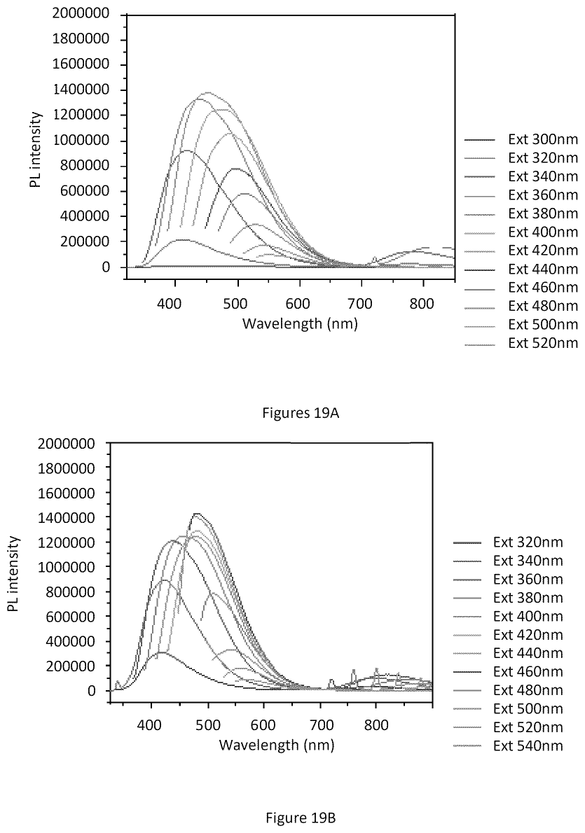

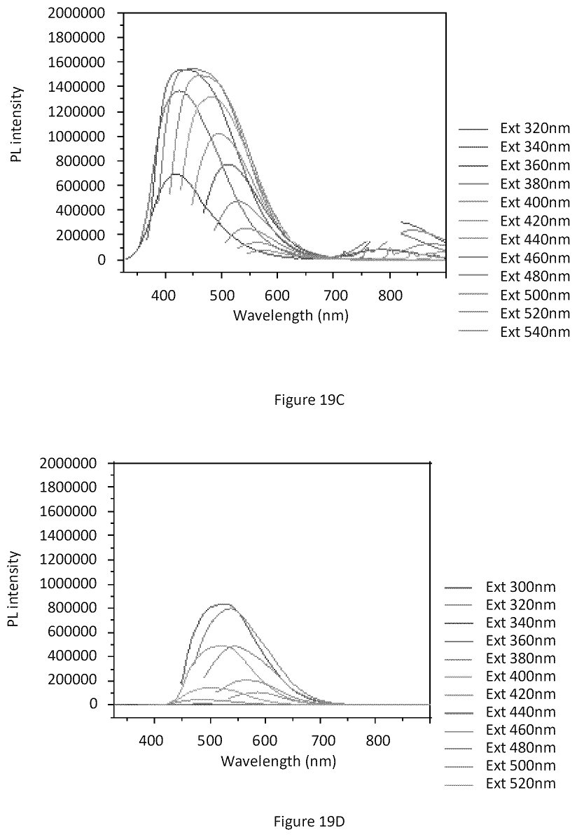

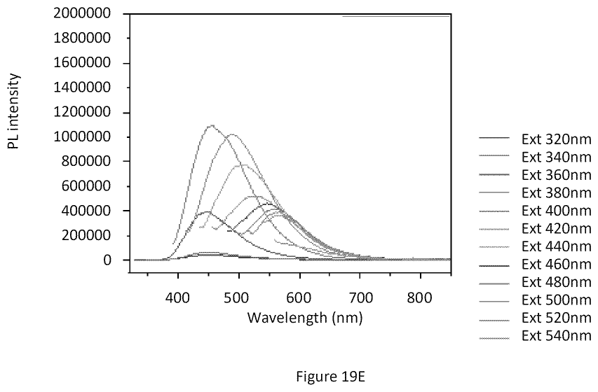

TEM images of the CQDs are shown in FIGS. 13A-18B and their fluorescence spectra upon excitation between 300 and 540 nm are depicted in FIGS. 19A-19E. Additionally, values for average particle size, quantum yield, PL decay time, and RI as well as a determination of cell viability were obtained. Values for each of these properties were obtained using similar methods to those used for the proteinogenic AA-CQDs, which are detailed hereinabove. Table 2 summarizes the results.

TABLE 2
Measured properties of CQDs derived
from nucleotides and canavanine

| | | PL Decay | Average | | |
|---|---|---|---|---|---|
| | QY | Time | Particle | | Cell |
| Type | (%) | (ns) | Size (nm) | RI | Viability |
| Adenine-CQDS | 79 | 5.28 | 6.0 | 1.952 | Yes |
| Uracil-CQDs | 54 | 4.61 | 7.0 | 1.622 | Yes |
| Thymine-CQDS | 57 | 4.55 | 6.0 | 1.541 | Yes |
| Cytosine-CQDs | 46 | 4.18 | 6.5 | 1.592 | Yes |
| Guanine-CQDs | 55 | 4.92 | 6.0 | 1.911 | Yes |
| Canavanine-CQDs | 45 | 3.50 | 8.0 | 1.965 | Yes |

As shown in Table 2 hereinabove, the measured properties of the CQDs which were synthesized from canavanine and the nucleotides, each fall within a similar range to those measured in the proteinogenic AA-CQDs. For example, the recorded QY values for CQDs synthesized from nucleotides ranged from 46% (Cytosine-CQDs) to 79% (Adenine-CQDs). Likewise, across PL decay time, average particle size and RI, the measured properties of the CQDs synthesized from nucleotides were found to be comparable to those of the proteinogenic AA-CQDs.

While the present invention has been particularly described, persons skilled in the art will appreciate that many variations and modifications can be made. Therefore, the invention is not to be construed as restricted to the particularly described embodiments, and the scope and concept of the invention will be more readily understood by reference to the claims, which follow.

1. A carbon quantum dot (CQD) derived from a monolithic substance including an amino acid, the CQD comprising:
a graphitic core; and
a passivation shell layer comprising at least one of a polyamide and a polyester, wherein the passivation shell layer is at least 15% by weight of the CQD;
wherein the CQD has a nitrogen content of at least 15% by weight of the CQD;
wherein the CQD is characterized by a fluorescence spectrum which is substantially devoid of an emission peak in the range of about 650-700 nm upon excitation at a wavelength in the range of 320-540 nm.

2. The CQD of claim 1, wherein the amino acid is a positively charged amino acid selected from the group consisting of histidine, arginine, and lysine.

3. The CQD of claim 1, wherein the amino acid is an uncharged polar amino acid selected from the group consisting of threonine and asparagine.

4. The CQD of claim 1, wherein the graphitic core has electron diffraction lattice fringes with d-spacing in a range of 0.20-0.24 nm.

5. The CQD of claim 1, wherein the passivation shell layer is within a range of 16%-20% by weight of the CQD, and further comprises at least one functional group selected from —COOH (carboxyl), —NH₂ (amino), —OH (hydroxyl), —CH═O (formyl), and —C═O (carbonyl).

6. The CQD of claim 1, having a carbon content of at least 63% by weight of the CQD, a quantum yield at or above 45%, a refractive index at or above 1.35, and/or a fluorescence decay time at or above 0.05 ns.

7. A carbon quantum dot (CQD) derived from a nucleotide or metabolite thereof, the CQD comprising:
a graphitic core; and
a passivation shell layer, wherein the passivation shell layer is at least 15% by weight of the CQD;
wherein the CQD has a nitrogen content of at least 15% by weight of the CQD;
wherein the CQD is characterized by a fluorescence spectrum which is substantially devoid of an emission peak in the range of about 650-700 nm upon excitation at a wavelength in the range of 320-540 nm.

8. The CQD of claim 7, wherein the nucleotide or metabolite thereof is selected from the group consisting of adenine, adenosine, cytosine, guanine, thymine, and uracil.

9. The CQD of claim 8, wherein the CQD is derived in the presence of an organic acid selected from the group consisting of citric acid, malic acid, succinic acid, fumaric acid, tartaric acid, and oxalic acid.

10. The CQD of claim 7, wherein the passivation shell layer is within a range of 16%-20% by weight of the CQD and further comprises at least one functional group selected from —COOH (carboxyl), —NH₂ (amino), —OH (hydroxyl), —CH═O (formyl), and —C═O (carbonyl).

11. The CQD of claim 7, having a carbon content of at least 63% by weight of the CQD, a quantum yield at or above 45%, a refractive index at or above 1.35, and/or a fluorescence decay time at or above 0.05 ns.

12. A method of synthesizing a carbon quantum dot (CQD) derived from an amino acid, a nucleotide or a metabolite thereof, the method comprising:
a) dissolving an amino acid, a nucleotide or a metabolite thereof in an aqueous medium, thereby forming an aqueous solution;
b) heating the aqueous solution of step (a) to a temperature of about 200° C. or higher for a predetermined time period; and
c) gradually cooling the aqueous solution of step (b) to room temperature thereby recovering CQDs therefrom.

13. The method of claim 12, wherein step (a) is performed at a temperature in a range of 80° C.-90° C.

14. The method of claim 12, wherein step (a) comprises dissolving a nucleotide or a metabolite thereof in the presence of an organic acid selected from the group consisting of citric acid, malic acid, succinic acid, fumaric acid, tartaric acid, and oxalic acid.

15. The method of claim 14, wherein the organic acid is citric acid.

16. The method of claim 12, wherein the predetermined time period in step (b) is equal to or longer than 6 hours.

17. The method of claim 16, wherein the predetermined time period in step (b) is in a range of 6 to 10 hours.

18. The method of claim 12, wherein the gradual cooling of the aqueous solution in step (c) is performed at a cooling rate of 0.1-10° C./min.

19. The method of claim 18, wherein the gradual cooling of the aqueous solution in step (c) is performed at a cooling rate of about 0.5-1.5° C./min.

20. A CQD obtainable by the method of claim 12, wherein the CQD comprises a graphitic core and a passivation shell layer, wherein the passivation shell layer is at least 15% by weight of the CQD, wherein the CQD has a nitrogen content of at least 15% by weight of the CQD, and wherein the CQD is characterized by a fluorescence spectrum which is substantially devoid of an emission peak in the range of about 650-700 nm upon excitation at a wavelength in the range of 320-540 nm.
